(19) United States
(12) Patent Application Publication
(10) Pub. No.: US 2016/0133992 A1
(43) Pub. Date: May 12, 2016

(54) DRYING OF ELECTROLYTE MIXTURES CONTAINING ACIDS WITH MOLECULAR SIEVES

(71) Applicant: BASF SE, Ludwigshafen (DE)

(72) Inventors: Agnes VOITL, Schifferstadt (DE); Itamar Michael MALKOWSKY, Speyer (DE); Axel KIRSTE, Limburgerhof (DE)

(73) Assignee: BASF SE, Ludwigshafen (DE)

(21) Appl. No.: 14/903,092

(22) PCT Filed: Jul. 10, 2014
(86) PCT No.: PCT/EP2014/064811

§ 371 Date: Jan. 6, 2016

(30) Foreign Application Priority Data
Jul. 11, 2013 (EP) 13176177.7

(51) Int. Cl. H01M 10/0569; B01D 15/26; H01M 10/052

(52) U.S. Cl. CPC H01M 10/0569; H01M 10/052; B01D 15/26; H01M 2300/0028

(57) ABSTRACT

The present invention relates to a method for producing a dehydrated liquid mixture for use as a solvent for conducting salts (e.g. LiPF₆) wherein the water content is reduced, starting from a liquid starting mixture comprising one, two, three or more organic carbonates in a total amount of 90% by weight or more, based on the total amount of the liquid starting mixture and one, two or more compounds selected from the group consisting of (a) acids with a pKa below 4 and (b) precursors releasing acids with a pKa below 4 in the liquid starting mixture by hydrolysis.

The present invention relates to a method for producing a dehydrated liquid mixture for use as a solvent for conducting salts (e.g. LiPF₆) wherein the water content is reduced, starting from a liquid starting mixture comprising one, two, three or more organic carbonates in a total amount of 90% by weight or more, based on the total amount of the liquid starting mixture and one, two or more compounds selected from the group consisting of (a) acids with a pKa below 4 and (b) precursors releasing acids with a pKa below 4 in the liquid starting mixture by hydrolysis.

Another aspect of the present invention relates to a plant for producing a dehydrated liquid mixture for use as a solvent for conducting salts.

Dehydrated liquid mixtures for use as a solvent for conducting salts comprising water in very low amounts are for example needed in lithium ion batteries.

In lithium ion batteries an electrolyte mixture is present which comprises a conducting lithium salt and a dehydrated liquid solvent mixture, wherein the conducting salt is dissolved in the dehydrated liquid solvent mixture. Such solvents in the dehydrated liquid solvent mixture are usually organic carbonates (e.g. ethylene carbonate (EC), ethyl methyl carbonate (EMC), propylene carbonate (PC)). These organic carbonates are usually only commercially available exhibiting an initial water content in the range of from 100 to 1000 ppm.

However, the presence of water in lithium ion batteries usually causes undesired effects. When water is present in the electrolyte mixture of a lithium ion battery, not only the negative electrode performance of the battery is reduced but also decomposition of the conducting salt in the electrolyte mixture is accelerated. Although various conducting salts are known, lithium hexafluorophosphate (LiPF₆) is widely used in lithium ion batteries.

Neumann (Chemie Ingenieur Technik, 2011, 83, No. 11, 2042-2050) provides a general overview article regarding lithium ion secondary batteries. The document discloses that lithium hexafluorophosphat (LiPF₆) requires the absence of water. The reason is that LiPF₆ easily decomposes in the presence of water and forms hydrofluoric acid (HF) which causes massive corrosion in the battery. However, Neumann et al. do not disclose any method to reduce the water content in a liquid mixture comprising one or more organic carbonates in order to avoid formation of hydrofluoric acid.

It is generally accepted that the amount of water in the electrolyte mixture of lithium ion batteries needs to be 50 ppm or less to minimize the aforementioned effects. Therefore, removal of water from the electrolyte mixture or the liquid mixture meant as a solvent for the lithium conducting salt by a dehydration (removal of water) step is in many cases a significant step.

Examples of dehydration (i.e. removal of water) methods include (i) a method of separately drying a liquid solvent mixture (to obtain a dehydrated liquid solvent mixture) and a conducting salt and then mixing both to prepare an electrolyte mixture or (ii) a method of drying a mixture of a liquid solvent mixture and a conducting salt. The removal of water is for example conducted by using a desiccant, such as a zeolite, and/or by distillation.

For example, document Pahl et al. (Chemie Ingenieur Technik, 2010, 82, No. 5, 634-640) relates to the adsorptive removal of water from primary alcohols by means of zeolites. The document discloses that water can be efficiently removed (down to a low ppm range) by adsorption at molecular sieves such as zeolites of type 3A or 4A. However, document Pahl et al. is silent with respect to reducing the water content in a liquid mixture comprising one or more organic carbonates.

In this context it needs to be considered that usually an ion-exchangeable cation is present in a zeolite. If a zeolite is used for dehydrating a mixture of a liquid solvent mixture and a lithium conducting salt, the cation of the zeolite can cause an ion exchange reaction with the lithium ions during the dehydration process, contaminating the dehydrated electrolyte mixture.

Such ion exchange reactions can be avoided by drying method (i), wherein the liquid solvent mixture is separately dried (i.e. in the absence of a conducting salt) or by a specific type of method (ii) namely by applying a lithium zeolite, i.e. a zeolite wherein the original ion-exchangeable cation is ion-exchanged with lithium ions and therefore suited for drying in the presence of a lithium conducting salt.

US 2012/0141868 A1 discloses a lithium zeolite for treatment of nonaqueous electrolytic solutions and a treatment method of nonaqueous electrolytic solutions. The document discloses that on the basis of a method of type (i) the water amount can hardly be reduced to 50 ppm or less.

CN 1338789 A relates to a process for preparing organic carbonate solvents used for secondary lithium battery. The document discloses that a kind of organic carbonate solvents for secondary lithium battery is prepared by flowing organic carbonate through a drying column containing drying agent which may be for example molecular sieve for dewatering it, distilling in distillation tower at 50-200° C. and −0.05 to 0.1 MPa, and separating distillate. The document reports that the advantages are high purity up to 99.9% or more and low water content (lower than 5 ppm). However, the process is complicated as it includes both an adsorption and a distillation step.

Furthermore, drying methods of type (i) are often negatively affected by the zeolites used. In order to form mechanically stable shaped bodies (e.g. granules, pellets, etc) the zeolite material (powder) is typically mixed with a binder to compensate for the low binding affinity of the zeolite powder particles (the powder is the synthesis product of synthetic zeolite production). Examples of binders typically used include silica, alumina and clay. Typical clays include kaolin-type, bentonite-type, talc-type, pyrophillite-type, molysite-type, vermiculite-type, montmorillonite-type, chlorite-type and halloysite-type clays.

Such binder is not particularly limited in its amount added but is often added in an amount of 10 to 50 parts by weight per 100 parts by weight of zeolite powder particles. If the amount of the binder added is less than 10 parts by weight per 100 parts by weight of zeolite powder particles, the mechanically stable shaped bodies may collapse during use, whereas if it exceeds 50 parts by weight, the dehydration capacity (i.e. drying capacity) becomes insufficient.

One problem is that such binders usually contain large quantities of releasable metal ions (e.g. aluminium ions), which could contaminate the mixture to be dried (metal leaching). In order to reduce or avoid contamination of the mixture to be dehydrated by metal leaching, mechanically stable shaped bodies of binderless zeolites can be used. In order to form mechanically stable shaped bodies (e.g. granules, pellets, etc) from zeolite powder a binder is “used”. After formation of mechanically stable shaped bodies the binder is converted into a zeolite during the process of forming mechanically stable shaped bodies (formation of a binderless zeolite molecular sieve) e.g. by caustic digestion. By such a conversion (also named zeolitisation), the proportion of zeolite contained in the mechanically stable shaped bodies can be increased and ultimately, the mechanically stable shaped bodies can be composed entirely of zeolite.

Schuhmann et al. (Chemie Ingenieur Technik 2011, 83, No. 12, 2237-2243) disclose binderless zeolite molecular sieves of the LTA and FAU type. However, the document does not disclose the use of binderless zeolite molecular sieves in order to reduce the water content to a very low amount of e.g. less than 20 ppm in a liquid mixture comprising one or more organic carbonates.

Several additives are known in the art which are added to organic carbonates and conducting salts in a liquid electrolyte mixture or to a corresponding liquid solvent mixture. Such additives are for example compounds such as 1,3-propane sultone, succinic anhydride and sulfonyl benzene. The purpose of these compounds is for example to stabilize the organic carbonates, to improve the heat stability of the electrolyte mixture and/or to improve the electrochemical properties.

On the other hand, the use of additives may cause specific problems. Some of the aforementioned additives are sensitive towards water which causes the decomposition of the additive by hydrolysis. Furthermore, the decomposition/hydrolysis leads to the formation of detrimental products, e.g. strong acids, which in turn negatively affect the dehydration step.

For example, the compound of Formula (a),

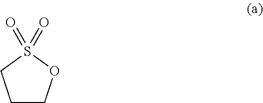

1,3-propane sultone, is subject to hydrolysis in the presence of water to give a compound of Formula (b),

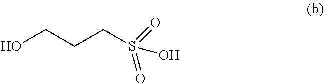

which is gamma-hydroxy propane sulfonic acid (3-hydroxy-1-propane sulfonic acid), a member of the class of hydroxyl alkane sulfonic acids. In general, hydroxyl alkane sulfonic acids are known to exhibit a pKa in a range of from −2 to 0. The compound of formula (b) has a pKa of −1.49.

It is known in the art that strong acids decompose zeolite molecular sieves, in particular sodium zeolite molecular sieves of type A. Ullmann's Encyclopedia of Industrial Chemistry (page 480, Vol. A 28, VCH Verlagsgesellschaft, 1996) discloses that strong acids decompose low-silica zeolites such as NaA and NaX by dissolving the aluminium atoms out of the framework, with consequent breakdown of the crystal structure.

Thus, the dehydration by contacting with an amount of a respective zeolite molecular sieve of a liquid solvent mixture comprising a certain amount of water and one, two or more compounds selected from the group consisting of (a) acids with a pKa below 4 and (b) precursors (e.g. 1,3-propane sultone) releasing acids (e.g. gamma-hydroxy propane sulfonic acid) with a pKa below 4 in the liquid solvent mixture by hydrolysis is typically accomplished by the following problems:
contamination of the dehydrated liquid mixture by ions released from (decomposed) zeolite molecular sieve materials, wherein the ions are mainly selected from the group consisting of sodium ions, aluminium ions, silicon ions (see the definition below), potassium ions, and calcium ions,
loss of dehydration capacity by decomposition (break down) of the crystal structure of the zeolite framework, and
loss of productivity of the dehydration process due to changed physical properties of the molecular sieve material (e.g. the decomposed molecular sieve material may destabilize the pressure conditions and loading flow rates in a dehydration process, requiring a complex measure of regulation).

Throughout the specification, the term “silicon ions” indicates various forms of cations and anions comprising silicon.

As mentioned above, binder-containing zeolite molecular sieves usually contain significant quantities of releasable metal ions. In the presence of strong acids two sources of releasable ions are present in binder-containing zeolite molecular sieves: (i) metal ions released by the binder (metal leaching) and (ii) ions released from the zeolite molecular sieve material which is decomposed by strong acids.

Thus, the presence of strong acids (or their precursors) during dehydration of liquid mixtures for use as a solvent for conducting salts by means of molecular sieves is typically avoided by the skilled person.

Instead, the skilled person typically avoids the decomposition of the molecular sieve material for example by dehydrating the liquid solvent mixture in the absence of compounds selected from the group consisting of (a) acids with a pKa below 4 and (b) precursors releasing acids with a pKa below 4 in the liquid solvent mixture by hydrolysis. A suitable dehydrated liquid mixture for use as a solvent for conducting salts can be produced by adding the additives only after the dehydration step, provided that the step of adding the additives does not significantly increase the amount of water in the dehydrated liquid mixture.

However, such a method includes a complex series of dehydration and mixing steps, prolonging the preparation time for a dehydrated liquid mixture for use as a solvent for conducting salts.

As a consequence, there is an ongoing demand for simplified methods for producing dehydrated liquid solvent mixtures comprising low amounts of water, and one, two or more compounds selected from the group consisting of (a) acids with a pKa below 4 and (b) precursors releasing acids with a pKa below 4 in the presence of water by hydrolysis, for use as a solvent for a conducting salt, in particular a lithium conducting salt. Preferably, such dehydrated liquid solvent mixtures should not be contaminated by the presence of ions.

It was, therefore, a first object of the present invention to provide a method for producing a dehydrated liquid mixture comprising a low amount of water for use as a solvent for a conducting salt, starting from a liquid starting mixture comprising a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture, water in a total amount of 20 ppm to 3500 ppm, based on the total amount of the liquid starting mixture, one, two or more compounds selected from the group consisting of (a) acids with a pKa below 4 and (b) precursors releasing acids with a pKa below 4 in the liquid starting mixture by hydrolysis, and optionally further constituents.

It was another object of the present invention to provide a method for producing a dehydrated liquid mixture of high purity which thus can contribute to a prolonged life time of a lithium ion battery and therefore generally to a better quality of these batteries.

According to a first aspect, the present invention provides a (first) method for producing a dehydrated liquid mixture comprising a low amount of water and being suitable for use as a solvent for conducting salts, the method comprising or consisting of (preferably consisting of) the following steps:
providing or preparing a liquid starting mixture comprising
   a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture,
   water in a total amount of from 20 ppm to 3500 ppm, based on the total amount of the liquid starting mixture,
   one, two or more compounds selected from the group consisting of (a) acids with a pKa below 4 and (b) precursors releasing acids with a pKa below 4 in the liquid starting mixture by hydrolysis,
   optionally further constituents,
contacting the liquid starting mixture with an amount of a zeolite molecular sieve such that
   the water content in the mixture is reduced.

Throughout this text the term “C1 to C8 alcohols” indicates alcohols having 1 to 8 carbon atoms. Preferably, a C1 to C8 alcohol is (i) aliphatic, (ii) substituted or unsubstituted, and (iii) branched or unbranched.

Furthermore, throughout this text the term “further constituents” indicates constituents other than water, organic carbonates, acetic acid esters of C1 to C8 alcohols, butyric acid esters of C1 to C8 alcohols, and compounds selected from the group consisting of (a) acids with a pKa below 4 and (b) precursors releasing acids with a pKa below 4 in the liquid starting mixture by hydrolysis.

Preferred acetic acid esters of C1 to C8 alcohols are acetic acid methyl ester and acetic acid ethyl ester. Preferred butyric acid esters of C1 to C8 alcohols are butyric acid methyl ester and butyric acid ethyl ester.

Preferably, in the method according to the invention (as described above, in particular in a method described as being preferred) the total amount of acetic acid esters of C1 to C8 alcohols and butyric acid esters of C1 to C8 alcohols is in the range of from 0 to 33.4% by weight, based on the total amount of the liquid starting mixture.

Preferred is a method according to the invention (as described above, in particular a method described as being preferred), wherein
the total amount of acetic acid esters of C1 to C8 alcohols and butyric acid esters of C1 to C8 alcohols is in the range of from 0 to 45% by weight, preferably in the range of from 0 to 33.4% by weight, based on the total amount of the liquid starting mixture,
   and/or
the liquid starting mixture comprises water in a total amount of 3500 ppm to 20 ppm, preferably in a total amount of 500 ppm to 20 ppm, based on the total amount of the liquid starting mixture.

Preferred is a method according to the invention (as described above, in particular a method described as being preferred), wherein the total amount of acetic acid esters of C1 to C8 alcohols and butyric acid esters of C1 to C8 alcohols is in the range of from 0 to 10% by weight, and preferably is 0% by weight, based on the total amount of the liquid starting mixture. E.g., if the total amount of acetic acid esters of C1 to C8 alcohols and butyric acid esters of C1 to C8 alcohols is 0% by weight (or, e.g., 5% by weight), the total amount of organic carbonates is 90% by weight (or, e.g., 85% by weight, respectively) or more, based on the total amount of the liquid starting mixture.

Correspondingly, preferred is a method for producing a dehydrated liquid mixture comprising a low amount of water and being suitable for use as a solvent for conducting salts, the method comprising or consisting of (preferably consisting of) the following steps:
providing or preparing a liquid starting mixture comprising
   one, two, three or more organic carbonates in a total amount of 90% by weight or more, based on the total amount of the liquid starting mixture,
   water in a total amount of from 20 ppm to 3500 ppm, preferably from 20 ppm to 500 ppm, based on the total amount of the liquid starting mixture,
   one, two or more compounds selected from the group consisting of (a) acids with a pKa below 4 and (b) precursors releasing acids with a pKa below 4 in the liquid starting mixture by hydrolysis,
   optionally further constituents,
contacting the liquid starting mixture with an amount of a zeolite molecular sieve such that
   the water content in the mixture is reduced.

A significant and unexpected advantage of this invention is the high purity of the dehydrated liquid mixture produced, i.e. surprisingly no significant amounts of ions are released from the zeolite molecular sieve under the process conditions chosen. As a consequence, the life time of a corresponding lithium ion battery is usually prolonged.

Throughout the specification, the term “precursor” indicates a compound releasing one or more than one acids with a pKa below 4 in the liquid starting mixture by hydrolysis, the liquid starting mixture comprising water in a total amount of from 20 ppm to 3500 ppm, preferably from 20 ppm to 500 ppm.

In the method according to the invention (as described above) the one, two or more compounds selected from the group consisting of (a) acids with a pKa below 4 and (b) precursors releasing acids with a pKa below 4 in the liquid starting mixture by hydrolysis are present in the liquid starting mixture when contacting the liquid starting mixture with an amount of a zeolite molecular sieve such that the water content in the mixture is reduced. In case that according to an option of the method of the invention precursors are present in the liquid starting mixture, acids with a pKa below 4 are released (formed) by hydrolysis before and/or during the contacting step. Thus, the contacting step of methods of the invention for producing a dehydrated liquid mixture for use as a solvent for conducting salts is carried out in the presence of at least minor amounts of acid with a pKa below 4.

The term “molecular sieve” as used in the art indicates a class of substances with discrete pore structures that can act as an adsorbent, discriminating between molecules on the basis of size.

The term “zeolite molecular sieve” as used in the art indicates a specific class of molecular sieves, wherein the substances mainly comprise alkali metal crystalline aluminosilicates with a framework structure, exhibiting the general formula M_{x/n} [(AlO₂)ₓ(SiO₂)_{y}]zH₂O, wherein “M” represents the nonframework metal cation, and “n” is its charge. Synthetic and natural zeolites are known. Natural zeolites are for example clinoptilolite and chabazite. Synthetic zeolites are for example zeolite 4A, zeolite P and zeolite ZSM-5. All these zeolites exhibit as small a pore size as about 6 Angstrom or less and, among others, zeolite 4A has a 8-membered ring pore structure giving a pore size of even 4 Angstrom. For a more detailed definition and discussion of zeolites reference is made to the January 1975 publication of the International Union of Pure and Applied Chemistry entitled “Chemical Nomenclature, and Formulation of Compositions, of Synthetic and Natural Zeolites”.

Preferred is a method according to the invention (as described above), wherein the liquid starting mixture comprises one, two or more compounds selected from the group consisting of (a) acids with a pKa below 0 and (b) precursors releasing acids with a pKa below 0 in the liquid starting mixture by hydrolysis.

Preferred is a method according to the invention (as described above, in particular in methods described as being preferred), wherein the zeolite molecular sieve is a binderless zeolite molecular sieve.

The term “binderless zeolite molecular sieve” as used in the art indicates a zeolite molecular sieve wherein the total amount of alkali metal crystalline aluminosilicates with a framework structure (as defined above) is preferably 95 to 100% by weight (usually almost 100% by weight), based on the total amount of the binderless zeolite molecular sieve, which means that no significant amount of binder is contained in the binderless zeolite molecular sieve.

Preferred is a method according to the invention (as described above, in particular a method described as being preferred), wherein by contacting the liquid starting mixture with an amount of a zeolite molecular sieve the water content in the mixture is reduced to an amount of less than 20 ppm, based on the total amount of the dehydrated liquid mixture.

Even more preferred is a method according to the invention (as described above, in particular a method described as being preferred), wherein by contacting the liquid starting mixture with an amount of a binderless zeolite molecular sieve the water content in the mixture is reduced to an amount of less than 20 ppm, based on the total amount of the dehydrated liquid mixture.

A significant and unexpected advantage of the method of the present invention is that it allows for reducing the water content to less than 20 ppm by means of a single step of contacting the liquid starting mixture (as described above) with a zeolite molecular sieve, preferably with a binderless zeolite molecular sieve.

Throughout the specification, the water concentration (amount of water in the liquid starting mixture and in the dehydrated liquid mixture, respectively) is determined quantitatively by coulometric Karl Fischer measurement, if not indicated otherwise.

Throughout the specification, the term “ppm” denotes a mass fraction, if not indicated otherwise.

Preferably, in the method according to the invention (as described above, in particular in methods described as being preferred) the contacting step is conducted at a temperature in the range of from −20 to 100° C., more preferably at a temperature in the range of from −20 to 60° C., most preferably at a temperature in the range of from −20 to 40° C.

Preferably, in the method according to the invention (as described above, in particular in methods described as being preferred) the contacting step is conducted at a pressure of maximum 50 bar, preferably in the range of from very close to zero to 50 bar, more preferably in the range of from 0.5 to 10 bar, most preferably at a pressure in the range of from 1 to 1.5 bar.

In the method according to the invention (as described above, in particular in methods described as being preferred) the contacting step is even more preferably conducted at a temperature in the range of from −20 to 40° C. and (preferably) at a pressure in the range of from 1 to 1.5 bar.

Also, if the liquid starting mixture solidifies at least partially in the temperature range of from −20° C. to 60° C. (preferably in the temperature range of from 20 to 60° C.), preferred is a method, wherein the contacting step is conducted at a temperature in the range of from 0 to 30 Kelvin, preferably 0 to 20 Kelvin, above the corresponding solidification temperature of the liquid starting mixture.

In some cases, it is preferred that the method according to the invention (as described above, in particular a method described as being preferred) consists of the steps indicated above, i.e. of the following steps:
providing or preparing a liquid starting mixture comprising
   one, two, three or more organic carbonates in a total amount of 90% by weight or more, based on the total amount of the liquid starting mixture,
   water in a total amount of from 20 ppm to 3500 ppm, preferably in a total amount of from 20 ppm to 500 ppm, based on the total amount of the liquid starting mixture,
   one, two or more compounds selected from the group consisting of (a) acids with a pKa below 4 and (b) precursors releasing acids with a pKa below 4 in the liquid starting mixture by hydrolysis,
   optionally further constituents,
contacting the liquid starting mixture with an amount of a zeolite molecular sieve such that
   the water content in the mixture is reduced.

Even more preferably, in this case one or both of the aforementioned features regarding temperature and pressure and/or one or more features of additional preferred embodiments described above or below apply.

As mentioned above, a significant and unexpected advantage of this invention is that no significant amounts of ions are released into the dehydrated liquid mixture from the zeolite molecular sieve.

Preferred is a method according to the invention (as described above, in particular a method described as being preferred), wherein the total concentration of ions selected from the group consisting of sodium ions, aluminium ions, silicon ions, potassium ions and calcium ions, in the dehydrated liquid mixture is 25 ppm or less, preferably 15 ppm or less, more preferably 5 ppm or less, based on the total amount of the dehydrated liquid mixture.

If the total concentration of the aforementioned ions is in the ranges as described above (in particular in the ranges described as being preferred) the life time (and thus the quality) of a corresponding lithium ion battery is usually prolonged.

Preferred is a method according to the invention (as described above, in particular a method described as being preferred), wherein the total concentration of ions selected from the group consisting of sodium ions and aluminium ions in the dehydrated liquid mixture is 5 ppm or less, preferably the total concentration of ions selected from the group consisting of sodium ions, aluminium ions and silicon ions in the dehydrated liquid mixture is 5 ppm or less, more preferably the total concentration of ions selected from the group consisting of sodium ions, aluminium ions, silicon ions and potassium ions in the dehydrated liquid mixture is 5 ppm or less, most preferably the total concentration of ions selected from the group consisting of sodium ions, aluminium ions, silicon ions, potassium ions and calcium ions is 5 ppm or less, based on the total amount of the dehydrated liquid mixture.

Preferred is a method according to the invention (as described above, in particular a method described as being preferred), wherein in the dehydrated liquid mixture the concentration of each individual ion selected from the group consisting of sodium ions, aluminium ions, silicon ions, potassium ions and calcium ions is 5 ppm or less (preferably as close to 0 ppm as possible), preferably 3 ppm or less (preferably as close to 0 ppm as possible), more preferably 1 ppm or less (preferably as close to 0 ppm as possible), based on the total amount of the dehydrated liquid mixture. Preferably, the dehydrated liquid mixture is free of sodium ions and/or free of aluminium ions and/or free of silicon ions and/or free of potassium ions and/or free of calcium ions.

If not indicated otherwise, in order to determine whether the concentration of a given ion is 5 ppm or less, is 3 ppm or less, or is even 1 ppm or less the ion concentration should be quantitatively determined by GC (gas chromatography) combined with ICP-MS (inductively coupled plasma mass spectrometry) measurements. The skilled person is aware of the practical requirements to be met in order to arrive at reliable results.

Preferred is a method according to the invention (as described above, in particular a method described as being preferred), wherein the one, two or more compounds selected from the group consisting of (a) acids with a pKa below 4 and (b) precursors releasing acids with a pKa below 4 in the liquid starting mixture by hydrolysis are selected from the group consisting of hydrofluoric acid, substituted or unsubstituted hydroxyl alkane sulfonic acids, phosphoric acid, phosphorous acid, substituted or unsubstituted alkane sultones, phosphoric acid esters and phosphorous acid esters.

Preferably, in the method according to the invention (as described above, in particular in a method described as being preferred) the substituents of substituted hydroxyl alkane sulfonic acids and substituted alkane sultones are not Cl and Br, preferably not halogen.

Preferred is a method according to the invention (as described above, in particular a method described as being preferred), wherein the one, two or more compounds selected from the group consisting of (a) acids with a pKa below 4 and (b) precursors releasing acids with a pKa below 4 in the liquid starting mixture by hydrolysis are selected from the group consisting of hydrofluoric acid, gamma-hydroxy propane sulfonic acid, 1-Methyl-gamma-hydroxy propane sulfonic acid, 1-Ethyl-gamma-hydroxy propane sulfonic acid, 1-Propyl-gamma-hydroxy propane sulfonic acid (1-Hydroxyethyl-1-butane sulfonic acid), 1-Butyl-gamma-hydroxy propane sulfonic acid (1-Hydroxyethyl-1-pentane sulfonic acid), 4-hydroxy-1-butane sulfonic acid, 1-Methyl-4-hydroxy-1-butane sulfonic acid, 1-Ethyl-4-hydroxy-1-butane sulfonic acid, 1-Octyl-4-hydroxy-1-butane sulfonic acid (1-Hydroxypropyl-1-nonane sulfonic acid), 5-hydroxy-1-pentane sulfonic acid, phosphoric acid, phosphorous acid, 1,3-propane sultone, 1-Methyl-1,3-propane sultone, 1-Ethyl-1,3-propane sultone, 1-Propyl-1,3-propane sultone, 1-Butyl-1,3-propane sultone, 1,4-butane sultone, 1-Methyl-1,4-butane sultone, 1-Ethyl-1,4-butane sultone and 1-Octyl-1,4-butane sultone, 1,5-pentane sultone, phosphoric acid esters and phosphorous acid esters.

More preferred is a method according to the invention (as described above, in particular a method described as being preferred), wherein the one, two or more compounds selected from the group consisting of (a) acids with a pKa below 4 and (b) precursors releasing acids with a pKa below 4 in the liquid starting mixture by hydrolysis are selected from the group consisting of hydrofluoric acid, gamma-hydroxy propane sulfonic acid, 4-hydroxy-1-butane sulfonic acid, 5-hydroxy-1-pentane sulfonic acid, 1,3-propane sultone, 1,4-butane sultone, 1,5-pentane sultone, most preferably selected from the group consisting of gamma-hydroxy propane sulfonic acid, 4-hydroxy-1-butane sulfonic acid, 1,3-propane sultone and 1,4-butane sultone.

This means that the compounds are preferably selected from the group consisting of

| Compound | formula | pKa |
|---|---|---|
| hydrofluoric acid | HF | 3, 2 |
| gamma-hydroxy propane sulfonic acid | 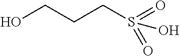 | −1, 5 |
| 1-Methyl-gamma-hydroxy propane sulfonic acid | 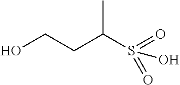 | below 4 |
| 1-Ethyl-gamma-hydroxy propane sulfonic acid | 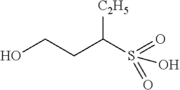 | below 4 |
| 1-Propyl-gamma-hydroxy propane sulfonic acid (1-Hydroxyethyl-1- butane sulfonic acid) | 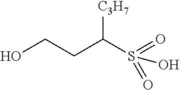 | below 4 |
| 1-Butyl-gamma-hydroxy propane sulfonic acid (1-Hydroxyethyl-1- pentane sulfonic acid) | 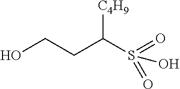 | below 4 |
| 4-hydroxy-1-butane sulfonic acid | 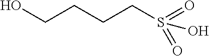 | −1,7 |
| 1-Methyl-4-hydroxy- 1-butane sulfonic acid | 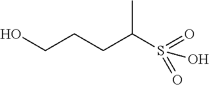 | below 4 |
| 1-Ethyl-4-hydroxy-1- butane sulfonic acid | 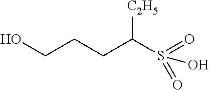 | below 4 |
| 1-Octyl-4-hydroxy-1- butane sulfonic acid (1-Hydroxypropyl-1- nonane sulfonic acid) | 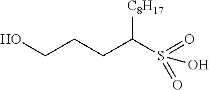 | below 4 |
| 5-hydroxy-1-pentane sulfonic acid | 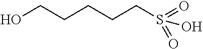 | below 4 |
| phosphoric acid | H₃PO₄ | 2, 1 (pKa1) |
| phosphorous acid | H₃PO₃ | 2, 0 (pKa1) |
| 1,3-propane sultone | 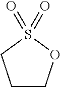 | — |
| 1-Methyl-1,3-propane sultone | 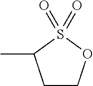 | — |
| 1-Ethyl-1,3-propane sultone | 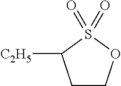 | — |
| 1-Propyl-1,3-propane sultone | 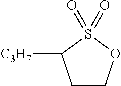 | — |
| 1-Butyl-1,3-propane sultone | 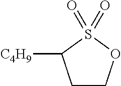 | — |
| 1,4-butane sultone | 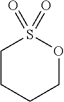 | — |
| 1-Methyl-1,4-butane sultone | 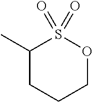 | — |
| 1-Ethyl-1,4-butane sultone | 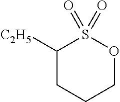 | — |
| 1-Octyl-1,4-butane sultone | 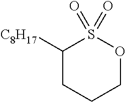 | — |
| 1,5-pentane sultone | 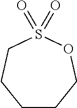 | — |
| phosphoric acid | H₂RₐPO₄ | — |
| monoester | | |
| phosphoric acid diester | H(Rₐ)₂PO₄ | — |
| phosphoric acid triester | (Rₐ)₃PO₄ | — |
| phosphorous acid | H₂RₐPO₃ | — |
| monoester | | |
| phosphorous acid diester | H(Rₐ)₂PO₃ | — |
| phosphorous acid triester | (Rₐ)₃PO₃ | — |

wherein each Ra independently of each other denotes an alkyl group, preferably an alkyl group having 1 to 8 carbon atoms.

The person skilled in the art is aware of the fact that the pKa of hydroxyl alkyl sulfonic acids is typically below 4, preferably in the range of from −2 to 0. In some cases the pKa was not determined more specifically but rather categorized as “below 4”.

Preferably, the 1,3-propane sultone, more preferably the alkyl sultones used in the method according to the invention (as described above, in particular in methods described as being preferred) are pre-dried.

In the method according to the invention only a limited total amount of acids with a pKa below 4 can be tolerated. If one, two or more compounds of an acid with a pKa below 4 are to be used in a liquid starting mixture the skilled person will favorably and is herewith encouraged to carry out a series of simple dehydration experiments testing a series of samples of various amounts of said acids. On the basis of these experiments the skilled person is able to evaluate the maximum total amount of said acids in the liquid starting mixture relative to the decomposition effect on the molecular sieve material. The skilled person will be also able to determine the optimum total amount of said acids in order to obtain a suitable dehydrated liquid mixture. The skilled person knows that the maximum total amount as well as the optimum total amount of said acids can be evaluated based on the total concentration of ions selected from the group consisting of sodium ions, aluminium ions, silicon ions, potassium ions and calcium ions, in the dehydrated liquid mixture. If the final concentration of each individual ion selected from the group consisting of sodium ions, aluminium ions, silicon ions, potassium ions and calcium ions is 5 ppm or less, preferably 1 ppm or less, based on the total amount of the dehydrated liquid mixture, the amount of said acids is acceptable.

The total concentration of precursors releasing acids with a pKa below 4 in the liquid starting mixture by hydrolysis in many cases can be significantly higher than the (final) concentration of released acids thereof with a pKa below 4. This means that the (final) total concentration of released acids with a pKa below 4 needs to be considered, wherein the release is caused by hydrolysis. The release by hydrolysis of such acids (i.e. the formation of such acids) depends (i) on the total amount of water in the liquid staring mixture and (ii) on the time for hydrolyzing the precursors to form the respective acids. Again, the skilled person will favorably and is herewith encouraged to carry out a series of simple experiments in order to determine the optimum total amount of precursors releasing acids with a pKa below 4 in the liquid starting mixture by hydrolysis (and thus the maximum amount of released acids under predetermined process conditions) taking into account (i) the total amount of water in the liquid starting mixture, which is in the range of from 20 ppm to 3500 ppm, preferably in the range of from 20 ppm to 500 ppm and (ii) the time for hydrolyzing the precursors before and during the contacting step. Again, the total amount of released acids with a pKa below 4 is acceptable if the final concentration of each individual ion selected from the group consisting of sodium ions, aluminium ions, silicon ions, potassium ions and calcium ions is 5 ppm or less, preferably 1 ppm or less, based on the total amount of the dehydrated liquid mixture.

Preferred is a method according to the invention (as described above, in particular in methods described as being preferred), wherein the maximum total amount of (a) acids with a pKa below 4 in the liquid starting mixture is 3500 ppm or less, preferably 1000 ppm or less, more preferably 500 ppm or less, even more preferably 250 ppm or less, most preferably 100 ppm or less, based on the total amount of the liquid starting mixture. The maximum total amount of (a) acids in this case is measured immediately before the contacting step. Thus, the maximum total amount of (a) acids with a pKa below 4 also includes the total amount of released acids with a pKa below 4 caused by hydrolysis of the precursors in the liquid starting mixture.

As mentioned above, the total amount of water influences the hydrolysis of the precursors. Thus, it is preferred that the total amount of water in the liquid starting mixture is as low as possible before contacting the liquid starting mixture with an amount of a zeolite molecular sieve. Preferred is a method according to the invention (as described above, in particular methods described as being preferred), wherein the total amount of water in the liquid starting mixture is in the range of from 20 ppm to 3000 ppm or in the range of from 20 ppm to 2000 ppm or in the range of from 20 ppm to 1000 ppm or in the range of from 20 ppm to 500 ppm or in the range of from 20 ppm to 400 ppm or in the range of from 20 ppm to 300 ppm or in the range of from 20 ppm to 200 ppm or in the range of from 20 ppm to 150 ppm, based on the total amount of the liquid starting mixture.

Own experiments have often shown that the method according to the invention (as described above, in particular methods described as being preferred) is in particular suited for reducing the water content in the mixture to an amount of less than 20 ppm if in the liquid starting mixture water is present in a total amount of from 3000 ppm to 20 ppm, preferably from 400 ppm to 20 ppm.

Further experiments have also shown that the method according to the invention (as described above, in particular methods described as being preferred) is well suited for reducing the water content in the mixture to an amount of less than 20 ppm in the liquid starting mixture if water is present in quite low concentrations, e. g. in a total amount of from 150 ppm to 20 ppm.

An organic carbonate is often also referred to as carbonate ester, or organocarbonate, and is a diester of carbonic acid. In the method according to the invention (as described above, in particular in methods described as being preferred) the one organic carbonate or each of the two, three or more organic carbonates is preferably a monomeric organic carbonate, i.e. the one organic carbonate or each of the two, three or more organic carbonate is not a polycarbonate.

Preferably, in the method according to the invention (as described above, in particular in methods described as being preferred), the one organic carbonate or each of the two, three or more organic carbonates, respectively, is a compound of Formula (I)

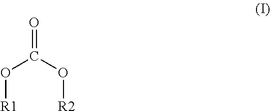

wherein independently for each of said organic carbonates
R1 and R2 in each case independently of each other denote an alkyl group having one or more carbon atoms
   or
R1 and R2 together constitute a substituted or unsubstituted alkylene bridge linking the esterified oxygens of the diester.

In some cases it is preferred that the alkylene bridge linking the esterified oxygens of the diester is unsubstituted. However, in other cases it is preferred that one or more hydrogen atoms of the alkylene bridge linking the esterified oxygens of the diester are substituted, wherein the substituents are selected from the group consisting of halogen, alkylidene, vinyl and alkyl. Preferred are substituents selected from the group consisting of F, Cl, Br, I, methylidene, ethylidene, vinyl, methyl, ethyl and propyl, more preferably F, Cl, methylidene, methyl, vinyl and ethyl.

Preferably, in the method according to the invention (as described above, in particular in methods described as being preferred) the total number of carbon atoms in R1 plus R2 is in the range of from 2 to 10, more preferably in the range of from 2 to 6, most preferably in the range of from 2 to 4.

If R1 and R2 independently of each other denote an alkyl group, preferably one or each of R1 and R2 independently of each other comprise a number of carbon atoms in the range of from 1 to 5, more preferably in the range of from 1 to 3, most preferably in the range of from 1 to 2.

An unsubstituted alkylene bridge linking the esterified oxygens of the diester is a functional group of formula —(CH₂)ₙ—, wherein n is a positive integer, preferably a positive integer in the range of from 2 to 10, more preferably in the range of from 2 to 6, even more preferably in the range of from 2 to 4, wherein most preferably n is 2. The dashes “—” in the formula indicate the bonds to the esterified oxygens of the diester.

Preferably, in the method according to the invention (as described above, in particular in methods described as being preferred) in a substituted alkylene bridge linking the esterified oxygens of the diester the total number of carbon atoms (in R1 plus R2) is in the range of from 2 to 10, more preferably in the range of from 2 to 6, even more preferably in the range of from 2 to 4, and wherein most preferably the number of carbon atoms in the main chain of the bridge linking the esterified oxygens of the diester is 2.

In some cases, a preferred organic carbonate, wherein R1 and R2 together constitute a substituted alkylene bridge linking the esterified oxygens of the diester is a compound of Formula (Ia)

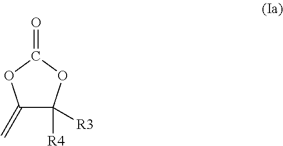

wherein R3 and R4 independently of each other are selected from the group consisting of hydrogen and alkyl, preferably hydrogen, methyl, ethyl and propyl, more preferably hydrogen, methyl and ethyl. If both R3 and R4 are hydrogen, the compound is 4-methylene-1,3-dioxolan-2-one.

Preferably, in the method according to the invention (as described above, in particular in methods described as being preferred), the one organic carbonate or each of the two, three or more organic carbonates, respectively, is a compound of Formula (I)

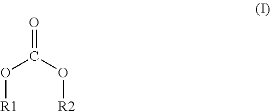

wherein independently for each of said organic carbonates
R1 and R2 independently of one another denote an alkyl group selected from the group consisting of methyl, ethyl, n-propyl, isopropyl, n-butyl, isobutyl, tert.-butyl, sec.-butyl, n-pentyl (amyl), 2-pentyl (sec.-pentyl), 3-pentyl, 2-methylbutyl, 3-methylbutyl (isopentyl), 3-methylbut-2-yl, 2-methylbut-2-yl and 2,2-dimethylpropyl (neopentyl), preferably selected from the group consisting of methyl and ethyl.

Preferably, in the method according to the invention (as described above, in particular in methods described as being preferred) the one organic carbonate or each of the two, three or more organic carbonates, respectively, is selected from the group consisting of dimethyl carbonate, diethyl carbonate, ethyl methyl carbonate, propylene carbonate, fluoroethylene carbonate, 4,4-dimethyl-5-methylene-1,3-dioxolan-2-one, 4-methyl-5-methylene-1,3-dioxolan-2-one, 4-methylene-1,3-dioxolan-2-one, vinyl ethylene carbonate and ethylene carbonate, preferably selected from the group consisting of ethylene carbonate, diethyl carbonate, ethyl methyl carbonate, dimethyl carbonate, fluoroethylene carbonate and propylene carbonate.

This means that the one organic carbonate or each of the two, three or more organic carbonates, respectively, is preferably selected from the group consisting of

| | | | total number of carbon |
|---|---|---|---|
| | | | atoms in R1 plus R2/total |
| | | | number of carbon atoms in |
| | | | main chain of bridge (i.e. |
| | | | total number of carbon |
| | | | atoms in R1 plus R2 |
| | | | minus carbon atoms in |
| compound | structural formula | R1, R2 | side chain of bridge) |
| dimethyl carbonate | 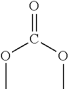 | R1 = R2 = methyl | 2/— |
| diethyl carbonate | 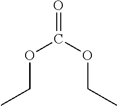 | R1 = R2 = ethyl | 4/— |
| ethyl methyl carbonate | 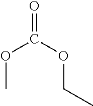 | R1 = methyl R2 = ethyl | 3/— |
| ethylene carbonate | 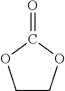 | R1 plus R2 = unsubstituted alkylene bridge = ethylene bridge | 2/2 |
| propylene carbonate | 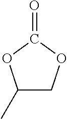 | R1 plus R2 = substituted alkylene bridge, substituent: methyl | 3/2 (i.e. 1 carbon atom in side chain) |
| 4,4-dimethyl-5- methylene-1,3- dioxolan-2-one | 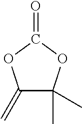 | R1 plus R2 = substituted alkylene bridge, substituents: methylidene, methyl, methyl | 5/2 (i.e. 3 carbon atoms in side chain) |
| 4-methyl-5- methylene-1,3- dioxolan-2-one | 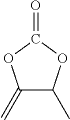 | R1 plus R2 = substituted alkylene bridge, substituents: methylidene, methyl | 4/2 (i.e. 2 carbon atoms in side chain) |
| 4-methylene-1,3- dioxolan-2-one | 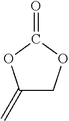 | R1 plus R2 = substituted alkylene bridge, substituent: methylidene | 3/2 (i.e. 1 carbon atom in side chain) |
| fluoroethylene carbonate | 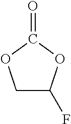 | R1 plus R2 = substituted alkylene bridge, substituent: F | 2/2 |
| vinyl ethylene carbonate (4-vinyl-1,3- dioxolan-2-one) | 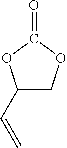 | R1 plus R2 = substituted alkylene bridge, substituent: vinyl | 4/2 (i.e. 2 carbon atoms in side chain) |

The aforementioned organic carbonates are often used in a liquid solvent mixture for a lithium conducting salt. In some cases ethylene carbonate and/or propylene carbonate are used as major solvent. However, ethylene carbonate shows high viscosity at room temperature (25° C.) so that additional organic carbonates are added in order to lower the viscosity at room temperature, e.g. dimethyl carbonate, diethyl carbonate, and/or ethyl methyl carbonate are added. Such mixtures, comprising one or more major solvents as well as additional organic carbonates in order to lower the viscosity are well usable/processable at room temperature.

Preferably, in the method according to the invention (as described above, in particular in methods described as being preferred), the liquid starting mixture comprises each of ethyl methyl carbonate, ethylene carbonate, and diethyl carbonate, wherein the ratio of the weights of ethyl methyl carbonate, ethylene carbonate and diethyl carbonate in the liquid starting mixture preferably is (>1):1:(<1),

or
wherein the liquid starting mixture comprises propylene carbonate, wherein the amount of propylene carbonate in the liquid starting mixture is higher than the amount of any other carbonate in the liquid starting mixture, preferably higher than the total amount of other carbonates, more preferably higher than 50% by weight of the liquid starting mixture, based on the total amount of the liquid starting mixture.

Preferably, in the method according to the invention (as described above, in particular in methods described as being preferred), the liquid starting mixture comprises less than 5% by weight of LiPF₆ as a further constituent, based on the total amount of the liquid starting mixture, preferably less than 5% by weight of Lithium conducting salts, more preferably less than 5% by weight of conducting salts at all.

More preferably, in the method according to the invention (as described above, in particular in methods described as being preferred) the liquid starting mixture comprises no LiPF₆, preferably no Lithium conducting salts, more preferably no conducting salts at all.

Preferably, in the method according to the invention (as described above, in particular in methods described as being preferred), 70% to 100% by weight of the zeolite molecular sieve contacted with the liquid starting mixture is a sodium zeolite molecular sieve, preferably a sodium zeolite molecular sieve of Linde Type 4A, based on the total amount of zeolite molecular sieve contacted with the liquid starting mixture.

Even more preferably, in the method according to the invention (as described above, in particular in methods described as being preferred), 70% to 100% by weight of the binderless zeolite molecular sieve contacted with the liquid starting mixture is a binderless sodium zeolite molecular sieve, preferably a binderless sodium zeolite molecular sieve of Linde Type 4A, based on the total amount of binderless zeolite molecular sieve contacted with the liquid starting mixture.

The amount of sodium ions in a zeolite molecular sieve material can be determined by XRPD measurements (X-ray powder diffraction).

Depending on the application, in some cases a method according to the invention (a method as described above, in particular a method described as being preferred) is preferred, wherein 70% to 100% by weight of the zeolite molecular sieve contacted with the liquid starting mixture is a (preferably binderless) lithium zeolite molecular sieve, preferably a (preferred binderless) lithium zeolite molecular sieve of Linde Type 4A, based on the total amount of zeolite molecular sieve contacted with the liquid starting mixture.

A binderless sodium zeolite molecular sieve of Linde Type 4A exhibits the typical composition of a unit cell of Na₁₂[AlO₂)₁₂(SiO₂)₁₂]*27H₂O. This binderless zeolite has, as already described above, a pore size of 4 Angstrom which is well suited to allow water molecules to enter into and get adsorbed within the framework structure. Furthermore, this binderless zeolite is not a substitution-type zeolite, which means that the sodium ions (i.e. the originally present sodium ions) are not replaced to a significant amount by any other type of cations, more preferably not replaced by lithium ions. As a consequence, binderless sodium zeolite molecular sieves of Linde Type 4A are cost efficient and well suited in the method according to the present invention for dehydration of a liquid starting mixture not comprising a lithium conducting salt (see above mentioned dehydration method (i)).

In some cases it is preferred that in the method according to the invention (as described above, in particular in methods described as being preferred) the binderless zeolite molecular sieve is of Linde Type 3A. A binderless zeolite molecular sieve of type 3A has a pore size of 3 Angstrom and is still well suited to allow water molecules to enter into the framework structure. However, the predominant cations are potassium ions (replacing or substituting the originally present sodium ions) in order to arrive at the pore size of 3 Angstrom.

In other cases it is preferred that in the method according to the invention (as described above, in particular in methods described as being preferred) the binderless zeolite molecular sieve is of Linde Type 5A. A binderless zeolite molecular sieve of type 5A has a pore size of 5 Angstrom and is still suited to allow water molecules to enter into and get adsorbed within the framework structure. However, the predominant cations are calcium ions (replacing or substituting the originally present sodium ions) in order to arrive at the pore size of 5 Angstrom.

In other rare cases it is preferred that in the method according to the invention (as described above, in particular in methods described as being preferred) the binderless zeolite molecular sieve is of Linde Type 13X. Molecular sieves of the X type vary from the A type in the internal character of the crystalline structure, zeolite 13X is of the faujasite type, its formula is Na₈₆(H₂O)₂₆₄[Al₈₆Si₁₀₆O₃₈₄]. A binderless zeolite molecular sieve of type 13X has a pore size of 10 Angstrom and is also still suited to allow water molecules to enter into and get adsorbed within the framework structure. The predominant cations are also sodium ions.

Preferably, in the method according to the invention (as described above, in particular in methods described as being preferred), the total amount of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, preferably in the range of from 0 to 33.4% by weight, based on the total amount of the liquid starting mixture, is 92% by weight or more, preferably 94% by weight or more, based on the total amount of the liquid starting mixture.

More preferably, in the method according to the invention (as described above, in particular in methods described as being preferred), the total amount of the one, two, three or more organic carbonates in the liquid starting mixture is 92% by weight or more, more preferably 94% by weight or more, based on the total amount of the liquid starting mixture.

Preferably, in the method according to the invention (as described above, in particular in methods described as being preferred), the liquid starting mixture comprises each of ethyl methyl carbonate, ethylene carbonate, and diethyl carbonate, wherein the ratio of the weights of ethyl methyl carbonate, ethylene carbonate and diethyl carbonate in the liquid starting mixture preferably is (>1):1:(<1), and wherein the total amount of ethyl methyl carbonate, ethylene carbonate, and diethyl carbonate in the liquid starting mixture is preferably 95% by weight or more, based on the total amount of the liquid starting mixture.

In some cases a method according to the invention (as described above, in particular methods described as being preferred) is preferred, comprising the step of providing or preparing a liquid starting mixture consisting of
one, two, three or more organic carbonates
water in a total amount of from 20 ppm to 3500 ppm, preferably from 20 ppm to 500 ppm, based on the total amount of the liquid starting mixture,
one, two or more compounds selected from the group consisting of (a) acids with a pKa below 4 and (b) precursors releasing acids with a pKa below 4 in the liquid starting mixture by hydrolysis,
further constituents in a total amount of 3% by weight or less, preferably 1% by weight or less, based on the total amount of the liquid starting mixture.

In some cases it is preferred that the total amount of further constituents in the liquid starting mixture is 0.1% by weight or less, more preferably no further constituents are present at all in the liquid starting mixture.

Preferably, the preferred feature regarding the total amount of further constituents in the liquid starting mixture is combined with features as described above and/or below, more preferably with features described above and/or below as being preferred. In particular preferred is that the aforementioned feature is combined with the feature of a binderless zeolite molecular sieve.

The binderless zeolite molecular sieve for reducing the water content in the liquid mixture may be provided as powder or as shaped bodies, the use of shaped bodies being preferred.

Preferably, shaped bodies of a binder-containing zeolite molecular sieve are not mixed with shaped bodies of the binderless zeolite molecular sieve. However, in some cases a certain amount of shaped bodies of the binder-containing zeolite molecular sieve in admixture with shaped bodies of the binderless molecular sieve is acceptable.

Thus, in the method according to the invention (as described above, in particular in methods described as being preferred) it is preferred, that the zeolite molecular sieve comprises or consists of shaped bodies, preferably of shaped bodies exhibiting a spherical or cylindrical shape.

Even more preferred is a method according to the invention (as described above, in particular methods described as being preferred), wherein the binderless zeolite molecular sieve comprises or consists of shaped bodies, preferably of shaped bodies exhibiting a spherical or cylindrical shape.

In some cases, alternative shapes of the shaped bodies are preferred including trefoil, elliptical and hollow shapes.

Preferably, in the method according to the invention (as described above, in particular in methods described as being preferred), the shaped bodies constituting the zeolite molecular sieve, preferably the shaped bodies exhibiting a spherical, cylindrical, trefoil, elliptical or hollow shape, exhibit a maximum diameter in the range of from 0.3 to 5.1 mm, preferably in the range of from 1.6 to 2.5 mm or 2.5 to 5.0 mm. The aforementioned features are preferably combined with the feature of a binderless zeolite molecular sieve.

Shaped bodies exhibiting the aforementioned shapes and maximum diameters are particularly well suited for use in a method of the present invention, in particular in technical large scale productions. Such shaped bodies are easy to handle, in particular for recycling procedures in order to regenerate the zeolite molecular sieve after contact with the liquid starting mixture.

Furthermore, shaped bodies of zeolite molecular sieve materials are in particular suited to be used in dehydration columns in order to:
stabilize the pressure conditions in a dehydration column (or other packed beds),
avoid or reduce the amount of powdery dust,
facilitate the exchange of the zeolite molecular sieve materials in the dehydration column (or other packed beds).

As mentioned above, zeolites are available as natural or synthetic zeolites. Own experiments have revealed that corresponding to the intended use both natural and synthetic zeolites can be used for dehydration. However, in a preferred method according to the invention (as described above, in particular in methods described as being preferred) the zeolite of the zeolite molecular sieve (preferably the binderless zeolite molecular sieve) is a synthetically manufactured zeolite. Synthetically manufactured zeolites are of consistently good quality, exhibit a maximum water adsorption capacity, are cost efficient in comparison to natural zeolites, and comprise very low amounts of contaminations (i.e. foreign ions).

Preferably, in the method according to the invention (as described above, in particular in methods described as being preferred), one, more than one, or all of the further constituents are selected from the group consisting of biphenyl, cyclohexylbenzene, ethylene sulfide, methacrylic acid esters of C1 to C8 alcohols, partly- or perfluorinated methacrylic acid esters of C1 to C8 alcohols, acrylic acid esters of C1 to C8 alcohols, partly- or perfluorinated acrylic acid esters of C1 to C8 alcohols, boronic acid esters of C1 to C8 alcohols, partly- or perfluorinated boronic acid esters of C1 to C8 alcohols, boric acid esters of C1 to C8 alcohols, partly- or perfluorinated boric acid esters of C1 to C8 alcohols, partly- or perfluorinated acetic acid esters of C1 to C8 alcohols, partly- or perfluorinated butyric acid esters of C1 to C8 alcohols, di alkyl sulfides, carboxylic acid nitriles (preferably selected from the group consisting of acrylonitrile and succinonitrile) and conducting salts, preferably selected from the group consisting of biphenyl, cyclohexylbenzene, acrylonitrile, methacrylic acid esters of C1 to C8 alcohols, partly- or perfluorinated methacrylic acid esters of C1 to C8 alcohols, acrylic acid esters of C1 to C8 alcohols and partly- or perfluorinated acrylic acid esters of C1 to C8 alcohols.

Preferred partly- or perfluorinated acetic acid esters of C1 to C8 alcohols are partly- or perfluorinated acetic acid methyl ester and acetic acid ethyl ester. Preferred partly- or perfluorinated butyric acid esters of C1 to C8 alcohols are partly- or perfluorinated butyric acid methyl ester and butyric acid ethyl ester.

The preferred feature regarding the one, more than one, or all of the further constituents is preferably combined with features of preferred embodiments of the present invention as described above (in particular with the preferred feature regarding the total amount of LiPF₆, lithium conducting salts and conducting salts at all, respectively) or below.

Biphenyl is used in order to reduce the flammability and/or to prevent overloading.

Preferably, in the method according to the invention (as described above, in particular in methods described as being preferred), the contacting is performed in a packed bed of a dehydration column loaded with the zeolite molecular sieve (preferably with the binderless zeolite molecular sieve). This preferred feature is preferably combined with features of preferred embodiments of the present invention as described above or below.

In preferred methods according to the invention (as described above, in particular in methods described as being preferred), the contacting is performed in a packed bed of a dehydration column loaded with the zeolite molecular sieve (preferably with the binderless zeolite molecular sieve) for a period of time up to 72 hours, more preferably for a period of time of up to 48 hours, even more preferably for a period of time up to 24 hours, most preferably for a period of time up to 12 hours.

Own experiments have shown that the contacting time (under process conditions as defined above) is surprisingly high. The skilled person would have had expected that the contacting time would be limited to a relatively short period of time, e.g. to less than 1 hour in order to avoid the decomposition of the zeolite molecular sieve material. However, own experiments have confirmed that the zeolite molecular sieve (preferably the binderless zeolite molecular sieve) exhibits a long-time stability in the presence of certain amounts of acids with a pKa below 4 or of precursors releasing acids with a pKa below 4 in the liquid starting mixture by hydrolysis.

Preferred is a method according to the invention (as described above, in particular a method described as being preferred), wherein the amount of a binderless zeolite molecular sieve is provided as a packed bed, preferably a packed column, loaded with the binderless zeolite molecular sieve.

In some cases a method according to the invention (as described above, in particular methods described as being preferred) is preferred, wherein the amount of a binderless zeolite molecular sieve is provided as a packed bed, preferably a packed column, loaded with the binderless zeolite molecular sieve, wherein the binderless zeolite molecular sieve comprises or consists of shaped bodies, wherein the shaped bodies exhibit a maximum diameter in the range of from 0.3 to 5.1 mm, preferably in the range of from 1.6 to 2.5 mm or 2.5 to 5.0 mm.

In a preferred method according to the invention (as described above, in particular in methods described as being preferred) the contacting is performed in a dehydration column loaded with the zeolite molecular sieve (as described above, preferably loaded with the binderless zeolite molecular sieves as described above), wherein the zeolite molecular sieve comprises or consists of shaped bodies, wherein the shaped bodies exhibit a maximum diameter in the range of from 0.3 to 5.1 mm, preferably in the range of from 1.6 to 2.5 mm or 2.5 to 5.0 mm.

A dehydration column is very well suited to operate in large scale productions to produce dehydrated liquid mixtures, preferably comprising water in an amount of less than 20 ppm. A dehydration column, loaded with the zeolite molecular sieve (as described above, preferably zeolite molecular sieves as described as being preferred) can be replaced in one piece in order to only shortly interrupt the large scale production. While a first dehydration column is regenerated a second column can be used to continue the large scale production. Furthermore, if a plant is used for large scale production two dehydration columns can be installed in parallel such that the process is preferably not interrupted at all.

Furthermore, in a packed bed such as a column the capacity of the zeolite molecular sieve material is optimally used due to the flow of the liquid starting mixture through the column containing the zeolite molecular sieve material (as described above, in particular binderless zeolite molecular sieves described as being preferred).

It is furthermore preferred that such a method according to the invention is conducted at a pressure of maximum 50 bar, preferably in the range of from very close to zero to 50 bar, more preferably in the range of from 0.5 to 10 bar, most preferably in the range of from 1 to 1.5 bar, and preferably at a temperature in the range of from −20 to 100° C., more preferably at a temperature in the range of from −20 to 60° C., most preferably at a temperature in the range of from −20 to 40° C. This preferred feature regarding pressure and temperature is preferably combined with features of preferred embodiments of the present invention as described above or below.

Preferred is a method according to the invention (as described above, in particular methods described as being preferred), consisting of the following steps:
providing or preparing a liquid starting mixture comprising
   one, two, three or more organic carbonates in a total amount of 90% by weight or more, based on the total amount of the liquid starting mixture,
   water in a total amount of from 20 ppm to 3500 ppm, preferably from 20 ppm to 500 ppm, based on the total amount of the liquid starting mixture,
   one, two or more compounds selected from the group consisting of (a) acids with a pKa below 4 and (b) precursors releasing acids with a pKa below 4 in the liquid starting mixture by hydrolysis,
   optionally further constituents,
contacting the liquid starting mixture with an amount of a zeolite molecular sieve, preferably a binderless zeolite molecular sieve, such that
   the water content in the mixture is reduced to an amount of less than 20 ppm, based on the total amount of the dehydrated liquid mixture.

Particularly preferred is a method according to the invention (as described above, in particular in methods described as being preferred), comprising the step of contacting the liquid starting mixture (as described above, in particular liquid starting mixtures described as being preferred) with an amount of a binderless zeolite molecular sieve (as described above, in particular binderless zeolite molecular sieves described as being preferred) such that the water content in the mixture is reduced to an amount of less than 15 ppm, preferably of less than 10 ppm, based on the total amount of the dehydrated liquid mixture.

For a given liquid starting mixture comprising a certain amount of water the skilled person in an attempt to produce a dehydrated liquid mixture comprising water in an amount of less than 20 ppm, and, in particular an amount of water within a predetermined concentration range (below 20 ppm), will select a binderless zeolite molecular sieve material and will favorably and is herewith encouraged to conduct a series of simple experiments in order to determine the minimum amount of the selected binderless zeolite molecular sieve material providing the required dehydration capacity. By doing so, the skilled person is both able to avoid the use of unnecessary large amounts of binderless zeolite molecular sieve and to avoid the use of too little amounts of binderless zeolite molecular sieve.

Own experiments have shown that the use of a binderless zeolite molecular sieve is usually more efficient than the use of a conventional, i.e. binder-containing zeolite molecular sieve of the same type.

In a preferred method according to the invention (as described above, in particular in methods described as being preferred) a liquid starting mixture comprising
one, two, three or more organic carbonates in a total amount of 90% by weight or more, based on the total amount of the liquid starting mixture,
water in a total amount of from 20 ppm to 3500 ppm, preferably from 20 ppm to 500 ppm, based on the total amount of the liquid starting mixture,
one, two or more compounds selected from the group consisting of (a) acids with a pKa below 4 and (b) precursors releasing acids with a pKa below 4 in the liquid starting mixture by hydrolysis,
optionally further constituents
   is prepared by mixing the one, two, three or more organic carbonates (in a total amount of 90% by weight or more, based on the total amount of the liquid starting mixture), water, and one, two or more compounds selected from the group consisting of (a) acids with a pKa below 4 and (b) precursors releasing acids with a pKa below 4 in the liquid starting mixture by hydrolysis, and optionally further constituents.

In some cases a method according to the invention (as described above, in particular in methods described as being preferred) is preferred, wherein the liquid starting mixture comprising
one, two, three or more organic carbonates in a total amount of 90% by weight or more, based on the total amount of the liquid starting mixture,
water in a total amount of from 20 ppm to 3500 ppm, preferably from 20 ppm to 500 ppm, based on the total amount of the liquid starting mixture,
one, two or more compounds selected from the group consisting of (a) acids with a pKa below 4 and (b) precursors releasing acids with a pKa below 4 in the liquid starting mixture by hydrolysis,
optionally further constituents.
   is prepared by a process comprising the steps of
providing a liquid pre-mixture of one, two, three or more organic carbonates in a total amount of 90% by weight or more, based on the total amount of the liquid starting mixture, water, and optionally further constituents,
pre-dehydrating the liquid pre-mixture to give a pre-dehydrated liquid mixture comprising a lower amount of water than the liquid pre-mixture,
mixing the pre-dehydrated liquid mixture with one, two or more compounds selected from the group consisting of (a) acids with a pKa below 4 and (b) precursors releasing acids with a pKa below 4 in the pre-dehydrated liquid starting mixture by hydrolysis,
optionally conducting further steps, in particular further dehydration and/or mixing steps.

Preferably, the pre-dehydration of the liquid pre-mixture to give a pre-dehydrated liquid mixture is achieved by contacting the liquid pre-mixture with an amount of zeolite molecular sieve, preferably an amount of binderless zeolite molecular sieve.

As mentioned above, the presence of one, two or more compounds selected from the group consisting of (a) acids with a pKa below 4 and (b) precursors releasing acids with a pKa below 4 in the liquid starting mixture by hydrolysis, might irreversibly affect the physical properties of the (preferably binderless) zeolite molecular sieve material contacted with the liquid starting mixture. Thus, a method according to the invention (as described above, in particular in methods described as being preferred) is in some cases preferred, wherein the (preferably binderless) zeolite molecular sieve is not recycled after the step of contacting the liquid starting mixture with an amount of said zeolite molecular sieve such that the water content in the mixture is reduced.

However, in other cases a method according to the invention (as described above, in particular in methods described as being preferred) is preferred, wherein the (preferably binderless) zeolite molecular sieve is recycled after the step of contacting the liquid starting mixture with an amount of said zeolite molecular sieve such that the water content in the mixture is reduced. The recycling of the zeolite molecular sieves can be conducted if the physical properties and/or the measure of toxicity of the sieves after the contacting step are acceptable. For example, 1,3-propane sultone is a cancerogenous compound and thus, the zeolite molecular sieve contacted with a liquid starting mixture comprising 1,3-propane sultone might not be safely recycled.

As mentioned in the beginning of the text, a suitable dehydrated liquid mixture for use as a solvent for conducting salts can be produced by adding to a pre-dehydrated liquid pre-mixture (i.e. after said liquid pre-mixture has been dehydrated) the one, two or more compounds selected from the group consisting of (a) acids with a pKa below 4 and (b) precursors releasing acids with a pKa below 4 in the dehydrated liquid mixture by hydrolysis. Such a method requires that the step of adding said compounds does not significantly increase the amount of water in the resulting mixture. However, in case the total amount of water is increased beyond an acceptable level an additional dehydration step is required in order to finally arrive at a dehydrated mixture ready for use as a solvent for conducting salts. Thus, according to a further aspect of the present invention, a preferred (second) method of the present invention comprises the following steps:
providing a liquid pre-mixture of one, two, three or more organic carbonates in a total amount of 90% by weight or more, based on the total amount of the liquid pre-mixture, water, and optionally further constituents,
pre-dehydrating the liquid pre-mixture to give a pre-dehydrated liquid mixture comprising a lower amount of water than the liquid pre-mixture,
mixing the pre-dehydrated liquid mixture with one, two or more compounds selected from the group consisting of (a) acids with a pKa below 4 and (b) precursors releasing acids with a pKa below 4 in the pre-dehydrated liquid mixture by hydrolysis,
optionally conducting further steps, in particular further dehydration and/or mixing steps,
   to give a resulting mixture comprising one, two, three or more organic carbonates in a total amount of 90% by weight or more, based on the total amount of the resulting mixture, and one, two or more compounds selected from the group consisting of (a) acids with a pKa below 4 and (b) precursors releasing acids with a pKa below 4 in the resulting mixture by hydrolysis,
determining the amount of water in said resulting mixture comprising one, two or more compounds selected from the group consisting of (a) acids with a pKa below 4 and (b) precursors releasing acids with a pKa below 4 in the resulting mixture by hydrolysis, and
if the amount of water determined is 20 ppm or above, preferably in the range of from 20 ppm to 3500 ppm, more preferably in the range of from 20 ppm to 500 ppm, based on the total amount of said resulting mixture, contacting said resulting mixture (as a liquid starting mixture) with an amount of a zeolite molecular sieve, preferably a binderless zeolite molecular sieve, such that the water content in the mixture is reduced.

In preferred situations said resulting mixture is a mixture comprising
one, two, three or more organic carbonates in a total amount of 90% by weight or more, based on the total amount of the liquid starting mixture,
water in a total amount of from 20 ppm to 3500 ppm, preferably from 20 ppm to 500 ppm, based on the total amount of the liquid starting mixture,
one, two or more compounds selected from the group consisting of (a) acids with a pKa below 4 and (b) precursors releasing acids with a pKa below 4 in the liquid starting mixture by hydrolysis,
optionally further constituents

Thus, said resulting mixture is a “liquid starting mixture” as discussed above regarding the first method of the present invention, and the mixture is then preferably treated according to preferred embodiments of the first method of the invention, as disclosed above.

Additionally, in preferred methods according to the invention (as described above, in particular in methods described as being preferred) the feature that the liquid starting mixture comprises a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture, is preferably combined with the preferred aforementioned embodiments of the method according to the present invention.

A second aspect of the present invention relates to a plant for producing a dehydrated liquid mixture for use as a solvent for conducting salts, the dehydrated mixture comprising
one, two, three or more organic carbonates in a total amount of 90% by weight or more, based on the total amount of the dehydrated liquid mixture,
water in an amount of less than 20 ppm, based on the total amount of the dehydrated liquid mixture,
one, two or more compounds selected from the group consisting of (a) acids with a pKa below 4 and (b) precursors releasing acids with a pKa below 4 in the dehydrated liquid mixture by hydrolysis, and
optionally further constituents,
   wherein the plant comprises
a first dehydration unit for reducing the amount of water in a mixture comprising organic carbonates in a total amount of 90% by weight or more, based on the total amount of the mixture,
a mixing unit for mixing the mixture produced in the first dehydration unit with one, two or more compounds selected from the group consisting of (a) acids with a pKa below 4 and (b) precursors releasing acids with a pKa below 4 in the mixture by hydrolysis,
transferring equipment for transferring the mixture produced in the first dehydration unit to the mixing unit,
a measuring unit for determining the amount of water in the mixture produced in the mixing unit,
a second dehydration unit for reducing the amount of water in the mixture produced in the mixing unit, the second dehydration unit comprising an amount of a zeolite molecular sieve, preferably a binderless zeolite molecular sieve, for contacting with said mixture,
transferring equipment for transferring the mixture produced in the mixing unit to the second dehydration unit.

Preferably, in the first dehydration unit for reducing the amount of water in a mixture comprising organic carbonates in a total amount of 90% by weight or more, based on the total amount of the mixture, the dehydration is carried out by contacting said mixture with a packed bed of an amount of zeolite molecular sieve, preferably by contacting with a packed bed of an amount of binderless zeolite molecular sieve. Thus, preferred is a plant according to the invention (as described above, in particular a plant described as being preferred), wherein the first dehydration unit is a column comprising a packed bed of an amount of a zeolite molecular sieve, preferably a binderless zeolite molecular sieve for contacting with said mixture.

The plant according to the present invention is preferably used for dehydrating a liquid starting mixture according to a method of the present invention. Thus, the present invention also relates to the use of a plant according to the present invention for conducting a method of the present invention. Correspondingly, the aforementioned features regarding the plant according to the present invention are preferably combined with the features regarding the method according to the invention (as described above, preferably features described as being preferred). In addition, the aforementioned feature of the method according to the invention that the liquid starting mixture comprises a total amount of 90% by weight or more, based on the total amount of the liquid starting mixture, of compounds selected from the group of organic carbonates, acetic acid esters of C1 to C8 alcohols and butyric acid esters of C1 to C8 alcohols, wherein the total amount of acetic acid esters of C1 to C8 alcohols and butyric acid esters of C1 to C8 alcohols is in the range of from 0 to 45% by weight, based on the total amount of the liquid starting mixture, is preferably combined with the features of a plant according to the present invention.

Preferred is a plant according to the invention (as described above, in particular a plant described as being preferred), wherein said transferring equipment for transferring the mixture produced in the mixing unit to the second dehydration unit is automated and provides for an automatic transfer depending on the result of the determination of the amount of water in the measuring unit.

Preferred is a plant according to the invention (as described above, in particular a plant described as being preferred), wherein the second dehydration unit is a column comprising a packed bed of an amount of a zeolite molecular sieve, preferably a binderless zeolite molecular sieve for contacting with said mixture.

In some cases, preferred is a plant according to the invention (as described above, in particular a plant described as being preferred), wherein the outlet side of the first dehydration unit is directly connected by means of a duct with a measuring and directing unit.

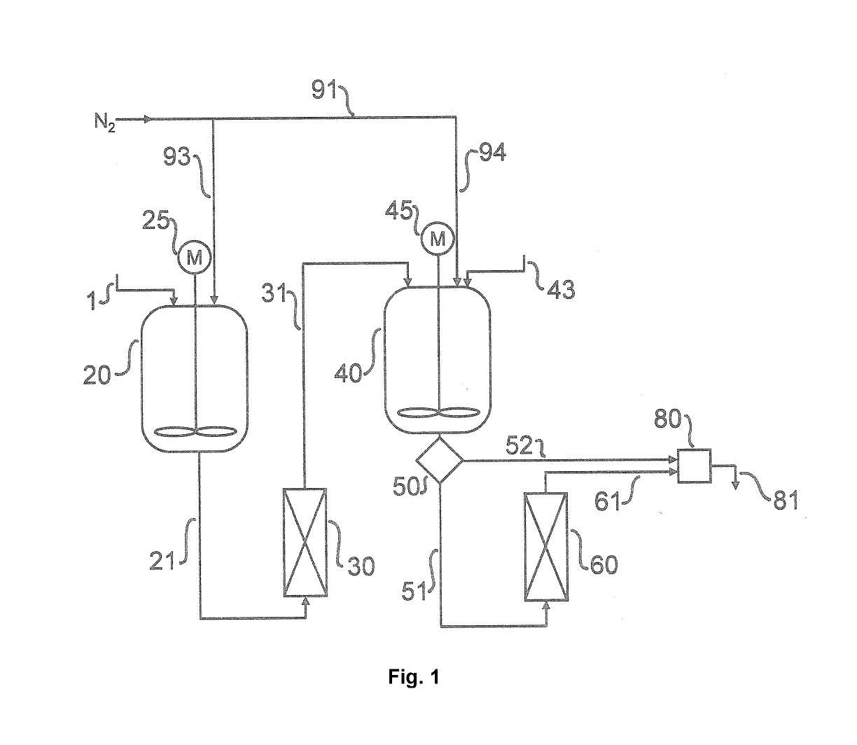

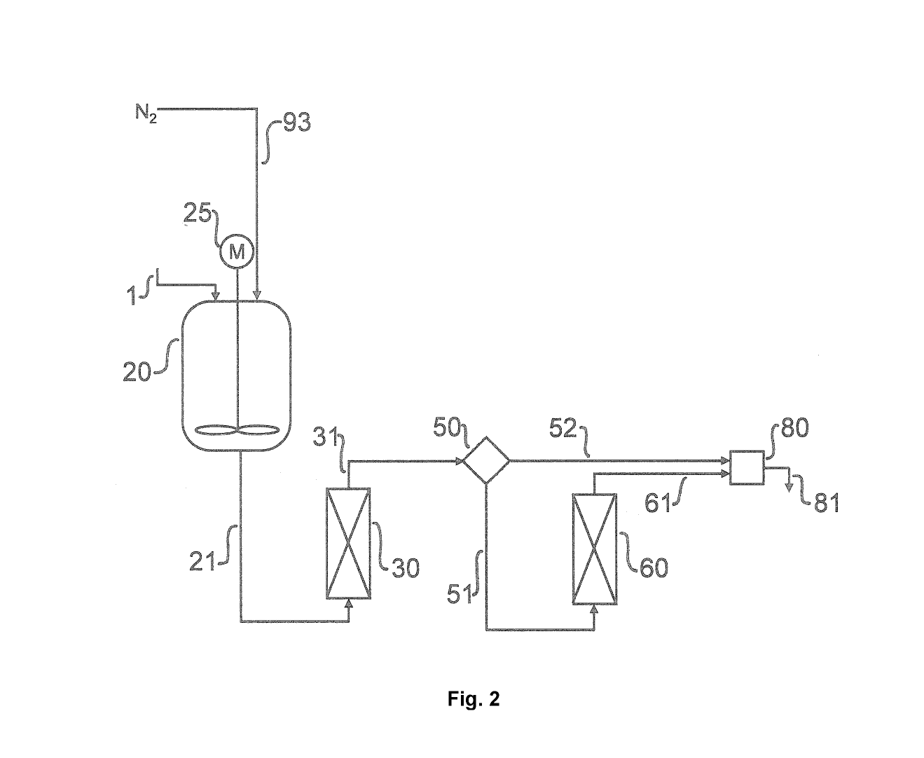

Examples of such a plant are shown in FIGS. 1 and 2.

FIG. 1 diagrammatically shows a plant for producing a dehydrated liquid mixture for use as a solvent for conducting salts, comprising a feed line 1 connected with a first mixing unit 20. The first mixing unit 20 comprises a first agitator 25 for a first mixing process. The first mixing unit 20 is connected by means of duct 21 with a first dehydration unit 30 comprising a dehydration column loaded with shaped bodies of binderless zeolite molecular sieve material. The outlet side of the dehydration unit 30 is connected by means of duct 31 with a second mixing unit 40, connected to a feed line 43 (for providing a feed of one, two or more compounds selected from the group consisting of (a) acids with a pKa below 4 and (b) precursors releasing acids with a pKa below 4 in the liquid mixture by hydrolysis) and comprising a second agitator 45 for a second mixing process. The outlet of the second mixing unit 40 is connected with a measuring and directing unit 50. The measuring and directing unit 50 is connected to (i) a filter unit 80 by means of duct 52 and (ii) a second dehydration unit 60 comprising a dehydration column loaded with shaped bodies of zeolite molecular sieve material by means of duct 51. The outlet side of the second dehydration unit 60 is connected with the filter unit 80 by means of duct 61. The outlet side of the filter unit 80 is connected with an effluent duct 81 for product withdrawal. The measuring and directing unit 50 is arranged to direct the outlet flow from the second mixing unit 40 to filter unit 80 (i) directly via duct 52 or (ii) indirectly via duct 51, second dehydration unit 60, and duct 61.

A nitrogen feed line 91 is connected with the first and second mixing unit 20 and 40, respectively, via two individual transfer ducts 93 and 94, respectively, in order to ventilate said mixing units with nitrogen gas while the mixing units are filled or emptied.

The outlet side of the filter unit 80 is connected with an effluent duct 81 for product withdrawal. The measuring and directing unit 50 is arranged to direct the outlet flow from the second mixing unit 40 to filter unit 80 (i) directly via duct 52 or (ii) indirectly via duct 51, second dehydration unit 60, and duct 61.

FIG. 2 diagrammatically shows a plant similarly designed as a plant according to FIG. 1. The reference numerals in FIG. 2 have the same or a similar meaning as the reference numerals in FIG. 1. However, according to FIG. 2 only the first mixing unit (mixing unit 20) is included (i.e. the second mixing unit 40, the second agitator 45, feed line 43, and individual transfer duct 94 are not included). The outlet side of the dehydration unit 30 is directly connected by means of duct 31 with the measuring and directing unit 50. In addition, the individual transfer duct 93 is the nitrogen feed line.

In other embodiments of a plant of the present invention (not depicted here) filter unit 80 is not present. Particularly relevant elements of the plant depicted in FIGS. 1 and 2 correspond to features stated in the attached set of claims and/or described above as being preferred.

For conducting a method according to the present invention two embodiments are described hereafter:

### EMBODIMENT 1

### Mixing—Dehydrating—Mixing—Optionally Again Dehydrating (According to FIG. 1)

One, two, three or more organic carbonates in a total amount of 90% by weight or more, based on the total amount of a liquid pre-mixture, water, and optional further constituents are filled into the first mixing unit 20 by means of feed line 1. With mixing by first agitator 25 the liquid pre-mixture is produced. The liquid pre-mixture is transferred into the first dehydration unit 30 for pre-dehydration by means of duct 21. There, the liquid pre-mixture is contacted with the (preferably binderless) zeolite molecular sieve material (loaded in a dehydration column) such that the water content in the liquid pre-mixture is reduced to an amount of less than 20 ppm. After pre-dehydration a pre-dehydrated liquid mixture is produced. The pre-dehydrated liquid mixture is transferred by means of duct 31 into the second mixing unit 40. Into the second mixing unit 40 additionally one, two or more compounds selected from the group consisting of (a) acids with a pKa below 4 and (b) precursors releasing acids with a pKa below 4 in the pre-dehydrated liquid mixture by hydrolysis are added by means of feed line 43 and subsequently mixed with the pre-dehydrated liquid mixture by second agitator 45. After this mixing process a resulting mixture is produced. The resulting mixture produced in the second mixing unit 40 is directly transferred into measuring and directing unit 50 in order to determining the amount of water in said resulting mixture. On the basis of the result obtained in measuring and directing unit 50 the resulting mixture can be processed in two different ways:

(a) If the amount of water determined is 20 ppm or above (e.g. in the range of from 20 ppm to 3500 ppm, preferably in the range of from 20 ppm to 500 ppm), based on the total amount of said resulting mixture, a liquid starting mixture comprising water in a total amount of from 20 ppm to 3500 ppm, preferably from 20 ppm to 500 ppm is present, which is transferred by means of duct 51 into the second dehydration unit 60 comprising a dehydration column loaded with shaped bodies of zeolite molecular sieve material. After (additional) dehydration in the second dehydration unit 60 a dehydrated liquid mixture is produced and transferred to the (optional) filter unit 80 by means of duct 61.
(b) If the amount of water determined is below 20 ppm, based on the total amount of said resulting mixture, a dehydrated liquid mixture is present, which is transferred by means of duct 52 to the filter unit 80.

After filtration of the dehydrated liquid mixture in filter unit 80 (in order to remove abrasion products of the zeolite molecular sieve materials and other dust particles from the raw materials and/or from the dehydration process) the filtered dehydrated liquid mixture is withdrawn from the process by the effluent duct 81.

The dehydrated liquid mixture obtained is ready for use as a solvent for conducting salts like e.g. LiPF₆. However, filtration could also be performed after mixing the dehydrated liquid mixture with one or more conducting salts like e.g. LiPF₆.

### EMBODIMENT 2

### Mixing—Dehydrating—Optionally Again Dehydrating (According to FIG. 2)

One, two, three or more organic carbonates in a total amount of 90% by weight or more, based on the total amount of the liquid starting mixture, water in a total amount of from 20 ppm to 3500 ppm, preferably from 20 ppm to 500 ppm, based on the total amount of the liquid starting mixture, one, two or more compounds selected from the group consisting of (a) acids with a pKa below 4 and (b) precursors releasing acids with a pKa below 4 in the liquid starting mixture by hydrolysis, and optionally further constituents, are filled into the first mixing unit 20 by means of feed line 1. With mixing by agitator 25 the liquid starting mixture is produced. The liquid starting mixture is transferred into the first dehydration unit 30 for dehydration by means of duct 21. There, the liquid starting mixture is contacted with the (preferably binderless) zeolite molecular sieve material (loaded in a dehydration column) such that the water content in the liquid starting mixture is reduced to an amount of less than 20 ppm. After dehydration in the first dehydration unit 30 a dehydrated liquid mixture is produced and, optionally, directly transferred to the (optional) filter unit 80 by means of duct 31, measuring and directing unit 50, and duct 52.

Alternatively, the total amount of water in the dehydrated liquid mixture can be determined in the measuring and directing unit 50. In case that the total amount of water in the dehydrated liquid mixture is 20 ppm or above a second dehydration step can optionally be performed by transferring the dehydrated liquid mixture with a total amount of water of 20 ppm or above by means of duct 51 into the second dehydration unit 60 comprising a dehydration column loaded with shaped bodies of zeolite molecular sieve material. After (additional) dehydration in the second dehydration unit 60 a dehydrated liquid mixture with a total amount of water below 20 ppm is produced and transferred to the filter unit 80 by means of duct 61.

After filtration of the dehydrated liquid mixture in filter unit 80 (in order to remove abrasion products of the zeolite molecular sieve materials and other dust particles from the raw materials and/or from the dehydration process) the filtered dehydrated liquid mixture is withdrawn from the process by the effluent duct 81.

The dehydrated liquid mixture obtained is ready for use as a solvent for conducting salts like e.g. LiPF₆. However, filtration could also be performed after mixing the dehydrated liquid mixture with one or more conducting salts like e.g. LiPF₆.

The present invention is described below in more detail by reference to Examples.

### EXAMPLES

### 1. Samples (I), (II) and (III)

The following samples have been prepared:

### Sample (I): Mixture of:

dimethyl carbonate: 20% by weight
ethyl methyl carbonate: 41% by weight
propylene carbonate: 37.5% by weight
1,4-butane sultone: 0% by weight
biphenyl: 1,464% by weight
water: 0.036% by weight

Sample (I) is a reference sample for purpose of comparison.

### Sample (II): Mixture of:

dimethyl carbonate: 20% by weight
ethyl methyl carbonate: 40% by weight
propylene carbonate: 36.5% by weight
1,4-butane sultone: 2% by weight
biphenyl: 1,461% by weight
water: 0.039% by weight

### Sample (III): Mixture of:

diethyl carbonate: 15.5% by weight
ethyl methyl carbonate: 46% by weight
propylene carbonate: 35% by weight
1,3-propane sultone: 1.5% by weight
biphenyl: 1,962% by weight
water: 0.038% by weight

Sample (I) is a reference sample and an example of a liquid starting mixture not comprising one, two or more compounds selected from the group consisting of (a) acids with a pKa below 4 and (b) precursors releasing acids with a pKa below 4 in the liquid starting mixture by hydrolysis.

Samples (II) and (III) are typical examples of liquid starting mixtures as used in the present invention.

Biphenyl (a further constituent according to the method of the present invention and present in Samples (I), (II) and (III)) is an additive widely used in lithium ion batteries in order to reduce the flammability.

### 1.1. Dehydration/Drying Procedure:

### 1.1.1 Dehydration Procedure of Sample (I) and Sample (II):

The dehydration of Samples (I) and (II) was performed by using small scale columns (total column volume: 18 ml) packed with 15 ml of binderless zeolite molecular sieve (BASF 4A BF Molecular Sieve (maximum diameter of the shaped bodies: in the range of from 1.6 to 2.5 mm; shape: spherical shape; density: 640 to 730 g/L)).

Samples (I) and (II) were trickled onto respective columns such that a supernatant was permanently on top of the bed. The respective dehydrated products were analyzed every 30 minutes for a total period of 300 minutes by coulometric Karl Fischer measurements (determination of the amount of water in the dehydrated liquid mixture). Throughout the 300 minutes a total amount of liquid starting mixture of approximately 2000 g was dehydrated. The dehydration of both samples was carried out at a temperature of 25° C. The dehydration/drying results (i.e. dehydration quality) are shown in section 1.2.1, Table 1.

### 1.1.2 Dehydration Procedure of Sample (III):

The following steps were carried out in a nitrogen purged glove box in order to avoid water desorption through the humidity of ambient air.

In a first step, a liquid starting mixture of Sample (III) was prepared by weighing and mixing the compounds of the liquid starting mixture (see 1.) in a glass flask. The zeolite molecular sieve 4A (binderless sodium zeolite molecular sieve 4A: BASF 4A BF Molecular Sieve (maximum diameter of the shaped bodies: in the range of from 1.6 to 2.5 mm, shape: spherical shape)) was also weighed and in a second step added to the prepared liquid starting mixture in order to contact the binderless zeolite molecular sieve 4A with the liquid starting mixture. After the second step, the glass flask was sealed with a cap (GI 45 cap) exhibiting a hole (diameter 5 mm), sealed with a septum in order to take samples. The total volume of the glass flask was 250 ml. The volume of the liquid starting mixture and the amount of the binderless zeolite molecular sieve 4A is shown in Table 2 of section 1.2.2 “Dehydration/drying results of Sample (III)”.

The contacting of the liquid starting mixture and the binderless zeolite molecular sieve 4A was carried out in the sealed glass flask for 24 hours at 25° C. with constant shaking in a shaking cabinet which was purged with nitrogen during the dehydration procedure.

For the determination of the water content (after 24 hours), a sample of the supernatant was taken with a syringe through the septum of the cap. Analysis was immediately carried out by coulometric Karl-Fischer measurement.

After dehydration, the dehydrated liquid mixture was separated from the molecular sieve material. As a result, the dehydrated liquid mixture (according to the invention) can be further used (e.g. for production of an electrolyte mixture by adding one or more conducting salts).

Syringes and needles were pre-dried in a desiccator for at least 48 hours.

The zeolite molecular sieve was unpacked and handled exclusively in a glove box under nitrogen atmosphere. The BASF 4A BF Molecular Sieve is a synthetically manufactured sodium binderless zeolite molecular sieve 4A with the formula Na₂O—Al₂O₃.2SiO₂.n H₂O and is an example of a preferred binderless zeolite molecular sieve, wherein 70% to to 100% by weight of the zeolite molecular sieve material contacted with the liquid starting mixture is a sodium zeolite molecular sieve.

### 1.2. Dehydration/Drying Results:

### 1.2.1 Dehydration/Drying Results of Samples (I) and (II):

TABLE 1
dehydration quality over a period of 300 minutes

| | Sample (I) | | Sample (II) | |
|---|---|---|---|---|
| | | amount of | | amount of |
| | | dehydrated | | dehydrated |
| time | H₂O | liquid | H₂O | liquid |
| [min] | [ppm] | mixture [g] | [ppm] | mixture [g] |
| 30 | 34.4 | 230.1 | 47.6 | 172.9 |
| 60 | 38.5 | 424.6 | 44.3 | 339.5 |
| 90 | 34.1 | 620.0 | 50.9 | 532.1 |
| 120 | 51.1 | 812.0 | 51.1 | 752.2 |
| 150 | 38.6 | 999.7 | 55 | 972.3 |
| 180 | 48.5 | 1179.3 | 52.6 | 1172.6 |
| 210 | 57.4 | 1412.2 | 56.2 | 1352.7 |
| 140 | 49.1 | 1630.7 | 58.8 | 1501.4 |
| 270 | 44.5 | 1811.9 | 55.1 | 1670.1 |
| 300 | 59.4 | 1986.9 | 58.9 | 1813.2 |

Sample (I) (reference sample) showed a constant dehydration quality over the period of 300 minutes (i.e. the total amount of water in the respective dehydrated mixtures was in the range of from 30 to 60 ppm, based on the total amount of the dehydrated liquid mixtures) at each measurement point.

Sample (II) comprising 1,4 butane sultone showed very similar results. The total amount of water in the respective dehydrated mixtures was also in the range of from 30 to 60 ppm). Furthermore, the dehydration capacity did not significantly decrease over time (in comparison to Sample (I)), i.e. the total amount of water in the dehydrated liquid mixture at 300 minutes was still in the same range of from 30 to 60 ppm, based on the total amount of the dehydrated liquid mixture.

Thus, Sample (II) is an example which shows that the dehydration of a liquid starting mixture can be performed in the presence of one, two or more compounds selected from the group consisting of (a) acids with a pKa below 4 and (b) precursors releasing acids with a pKa below 4 in the liquid starting mixture by hydrolysis.

Note: An additional experiment for an additional sample (IIa) was conducted using identical parameters, wherein the additional sample (IIa) according to the invention was prepared identically to Sample (II) with the only exception that 1,3-propane sultone was used instead of 1,4-butane sultone. The additional sample (IIa) was dehydrated as described above for Sample (II). The additional sample (IIa) like Sample (II) showed a constant dehydration quality over the period of time of 300 minutes. Furthermore, the total amount of water in the additional sample (IIa) was also in the range of from 30 to 60 ppm.

In addition, the concentration of each individual ion selected from the group consisting of sodium ions, aluminium ions, silicon ions, potassium ions and calcium ions in each sample was typically 5 ppm or less, based on the total amount of the dehydrated liquid mixture.

### 1.2.2 Dehydration/Drying Results of Sample (III):

TABLE 2
dehydration/drying results of Sample (III) using
binderless zeolite molecular sieve 4A

| Volume | amount of binderless zeolite | H₂O |
|---|---|---|
| [ml] | molecular sieve 4A [g] | [ppm] |
| 100 | 0.48 | 13.2 |

The result of Sample (III) (Table 2) shows that the water content in Sample (III) was reduced to an amount of less than 20 ppm (13.2 ppm) in the presence of 1,3-propane sultone and after contacting the liquid starting mixture with the above mentioned amount of binderless zeolite molecular sieve 4A.

Sample (III) is an example of a dehydrated liquid mixture wherein by contacting the liquid starting mixture with an amount of a zeolite molecular sieve the water content in the mixture is reduced to an amount of less than 20 ppm, based on the total amount of the dehydrated liquid mixture.

Note: An additional experiment with an additional sample (IIIa) was conducted wherein the additional sample (IIIa) was identical to Sample (III) with the only exception that 1,4-butane sultone was used instead of 1,3-propane sultone. This additional sample (IIIa) was dehydrated using the identical parameters as for Sample (III). In this additional experiment the total amount of water was likewise reduced to less than 20 ppm, based on the total amount of the dehydrated liquid mixture.

### 2. Sample (IV)

### Sample (IV): Mixture of:

ethyl methyl carbonate: 2 L
gamma-hydroxy propane sulfonic acid: 1000 ppm
water: 1690 ppm
ethanol: 5500 ppm

Sample (IV) was prepared as experimental sample in order to study the effect of a relatively high amount of gamma-hydroxy propane sulfonic acid (hydrolysis product of 1,3-propane sultone) in a liquid starting mixture having a total amount of water of 1690 ppm. In Sample (IV) ethanol was used in order to solubilize the gamma-hydroxy propane sulfonic acid in the ethyl methyl carbonate. The processing of Sample (IV) was not designed to reach a very low amount of water during the experiment, but was primarily designed to study the release of ions selected from the group consisting of sodium ions, aluminium ions, silicon ions and potassium ions over a period of 850 hours. Although the amount of water was continually monitored foreign water might have entered during each determination step of the water content.

### 2.1. Processing Procedure of Sample (IV):

Sample (IV) was processed by circulating said sample through a stainless steel column having a bed volume of 49 ml packed with a binderless zeolite molecular sieve (BASF 4A BF Molecular Sieve (maximum diameter of the shaped bodies: in the range of from 1.6 to 2.5 mm; shape: spherical shape; density: 640 to 730 g/L)). Sample (IV) was continuously pumped through the column for a total period of 850 hours (circulation flow rate: 1.5 L/h). Because of frequent sampling of the mixture, the total weight of Sample (IV) decreased to 1207 g during the experiment. After 460 hours experimental time the liquid mixture was spiked with a second amount of gamma-hydroxy propane sulfonic acid (1700 ppm), ethanol (3.9% by weight) and water (1500 ppm). The processing was carried out at a temperature of 25° C. The processing results are shown in Table 3 of the following section.

### 2.2. Processing Results of Sample (IV):

TABLE 3
Analysis of the concentration of ions in Sample (IV) selected from the
group consisting of sodium ions, aluminium ions, silicon ions and
potassium ions over a period of 850 hours

| | Sample (IV) | | | | | |
|---|---|---|---|---|---|---|
| time [h] | pH | H₂O [ppm] | Al [ppm] | K [ppm] | Na [ppm] | Si [ppm] |
| 0 | 1.01 | 1690 | <1 | <1 | <1 | <1 |
| 72 | — | 169 | <1 | <1 | <1 | <1 |
| 96 | — | 163 | — | — | — | <1 |
| 113 | — | 171 | <1 | <1 | <1 | — |
| 127 | — | 119 | — | — | — | <1 |
| 144 | — | 222 | <1 | <1 | <1 | — |
| 168 | — | 265 | <1 | <1 | <1 | — |
| 175 | — | — | — | — | — | <1 |
| 242 | — | 262 | <1 | <1 | <1 | — |
| 266 | — | — | — | — | — | <1 |
| 314 | — | 462 | <1 | <1 | <1 | — |
| 434 | 3 to 4 | — | — | — | — | — |
| 462 | 2 to 3 | 2339 | — | — | — | <1 |
| 506 | 2 to 3 | — | — | — | — | <1 |
| 578 | 2 to 3 | 1592 | <1 | <1 | <1 | — |
| 650 | 2 to 3 | 1537 | <1 | <1 | <1 | — |
| 794 | 1 to 2 | — | — | — | — | <1 |
| 842 | 1 to 2 | 1750 | <1 | <1 | <1 | — |
| 850 | 1 to 2 | — | — | — | — | — |

As shown in Table 3, a relatively high amount (i.e. more than 1000 ppm) of gamma-hydroxy propane sulfonic acid (as an example of a compound selected from the group consisting of (a) acids with a pKa below 4 and (b) precursors releasing acids with a pKa below 4 in the liquid mixture by hydrolysis) can be tolerated in the dehydration step. In order to analyze the individual concentrations of ions selected from the group consisting of sodium ions, aluminium ions, silicon ions and potassium ions under relatively severe acidic conditions the reduction of the total amount of water in the processed (i.e. dehydrated) mixture was only of secondary relevance.

1: A method for producing a dehydrated liquid mixture, comprising:
providing or preparing a liquid starting mixture comprising:
a total amount of 90% by weight or more, based on the total amount of the liquid starting mixture, of one or more compounds selected from the group consisting of an organic carbonate, an acetic acid ester of a C1 to C8 alcohol and a butyric acid ester of a C1 to C8 alcohol, wherein the total amount of the acetic acid ester of a C1 to C8 alcohol and the butyric acid ester of a C1 to C8 alcohol is 0% to 45% by weight, based on the total amount of the liquid starting mixture,
20 ppm to 3500 ppm of water, based on the total amount of the liquid starting mixture,
one or more compounds selected from the group consisting of an acid with a pKa below 4 and a precursor releasing acid with a pKa below 4 in the liquid starting mixture by hydrolysis, and
optionally a further constituent; and
contacting the liquid starting mixture with an amount of a zeolite molecular sieve such that the water content in the mixture is reduced to form a dehydrated liquid mixture.

2: The method according to claim 1, wherein the zeolite molecular sieve is a binderless zeolite molecular sieve.

3: The method according to claim 1, wherein by contacting the liquid starting mixture with an amount of the zeolite molecular sieve, the water content in the mixture is reduced to an amount of less than 20 ppm, based on the total amount of the dehydrated liquid mixture.

4: The method according to claim 1, wherein:
the dehydrated liquid mixture has a total concentration of ions of 25 ppm or less, based on the total amount of the dehydrated liquid mixture;
and the ions are selected from the group consisting of sodium ions, aluminum ions, silicon ions, potassium ions and calcium ions.

5: The method according to claim 4, wherein the concentration of each individual ion is 5 ppm or less based on the total amount of the dehydrated liquid mixture.

6: The method according to claim 1, wherein the one or more compounds are selected from the group consisting of hydrofluoric acid, gamma-hydroxy propane sulfonic acid, 1-Methyl-gamma-hydroxy propane sulfonic acid, 1-Ethyl-gamma-hydroxy propane sulfonic acid, 1-Propyl-gamma-hydroxy propane sulfonic acid (1-Hydroxyethyl-1-butane sulfonic acid), 1-Butyl-gamma-hydroxy propane sulfonic acid (1-Hydroxyethyl-1-pentane sulfonic acid), 4-hydroxy-1-butane sulfonic acid, 1-Methyl-4-hydroxy-1-butane sulfonic acid, 1-Ethyl-4-hydroxy-1-butane sulfonic acid, 1-Octyl-4-hydroxy-1-butane sulfonic acid (1-Hydroxypropyl-1-nonane sulfonic acid), 5-hydroxy-1-pentane sulfonic acid, phosphoric acid, phosphorous acid, 1,3-propane sultone, 1-Methyl-1,3-propane sultone, 1-Ethyl-1,3-propane sultone, 1-Propyl-1,3-propane sultone, 1-Butyl-1,3-propane sultone, 1,4-butane sultone, 1-Methyl-1,4-butane sultone, 1-Ethyl-1,4-butane sultone and 1-Octyl-1,4-butane sultone, 1,5-pentane sultone, a phosphoric acid ester and a phosphorous acid ester.

7: The method according to claim 1, wherein the liquid starting mixture comprises 20 ppm to 3000 ppm of water, based on the total amount of the liquid starting mixture.

8: The method according to claim 1, wherein the organic carbonate is a compound of Formula (I): 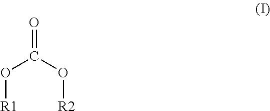
wherein:
R1 and R2 each independently denote an alkyl group having one or more carbon atoms; or
R1 and R2 together constitute a substituted or unsubstituted alkylene bridge linking esterified oxygens of the compound of Formula (I).

9: The method according to claim 1 consisting of:
providing or preparing a liquid starting mixture comprising:
a total amount of 90% by weight or more, based on the total amount of the liquid starting mixture, of compounds selected from the group consisting of an organic carbonate, an acetic acid ester of a C1 to C8 alcohol and a butyric acid ester of a C1 to C8 alcohol, wherein the total amount of the acetic acid ester of a C1 to C8 alcohol and the butyric acid ester of a C1 to C8 alcohol is 0% to 45% by weight, based on the total amount of the liquid starting mixture,
20 ppm to 3500 ppm of water, based on the total amount of the liquid starting mixture,
one or more compounds selected from the group consisting of an acid with a pKa below 4 and a precursor releasing acid with a pKa below 4 in the liquid starting mixture by hydrolysis, and
optionally a further constituent; and
contacting the liquid starting mixture with an amount of a zeolite molecular sieve such that the water content in the mixture is reduced to form a dehydrated liquid mixture.

10: The method according to claim 1 wherein:
the liquid starting mixture comprises a total amount of 90% by weight or more of one or more organic carbonates, based on the total amount of the liquid starting mixture; and
the liquid starting mixture is prepared by a process comprising:
providing a liquid pre-mixture comprising the a total amount of 90% by weight or more of one or more organic carbonates, based on the total amount of the liquid starting mixture, water, and optionally a further constituent,
pre-dehydrating the liquid pre-mixture to give a pre-dehydrated liquid mixture comprising a lower amount of water than the liquid pre-mixture,
mixing the pre-dehydrated liquid mixture with the one or more compounds selected from the group consisting of an acid with a pKa below 4 and a precursor releasing acid with a pKa below 4 in the liquid starting mixture by hydrolysis, and
optionally repeating the pre-hydrating and the mixing.

11: The method according to claim 1, wherein the zeolite molecular sieve is not recycled after the contacting.

12: A method for producing a dehydrated liquid mixture, comprising:
providing a liquid pre-mixture comprising one or more organic carbonates in a total amount of 90% by weight or more, based on the total amount of the liquid pre-mixture, water, and optionally a further constituent,
pre-dehydrating the liquid pre-mixture to give a pre-dehydrated liquid mixture comprising a lower amount of water than the liquid pre-mixture,
mixing the pre-dehydrated liquid mixture one or more compounds selected from the group consisting of an acid with a pKa below 4 and a precursor releasing acid with a pKa below 4 in the liquid starting mixture by hydrolysis, and
optionally repeating the pre-hydrating and the mixing;
wherein:
the method produces a resulting mixture comprising:
the one or more organic carbonates in a total amount of 90% by weight or more, based on the total amount of the resulting mixture, and
the one or more compounds selected from the group consisting of an acid with a pKa below 4 and a precursor releasing acid with a pKa below 4 in the liquid starting mixture by hydrolysis, and
the method further comprises:
determining the amount of water in said resulting mixture, and
contacting said resulting mixture with an amount of a zeolite molecular sieve, if the amount of water determined is 20 ppm or above, such that the water content in the mixture is reduced.

13: A plant for producing a dehydrated liquid mixture, the dehydrated mixture comprising:
one or more organic carbonates in a total amount of 90% by weight or more, based on the total amount of the dehydrated liquid mixture,
less than 20 ppm of water, based on the total amount of the dehydrated liquid mixture,
one or more compounds selected from the group consisting of an acid with a pKa below 4 and a precursor releasing acid with a pKa below 4 in the liquid starting mixture by hydrolysis, and
optionally a further constituent;
wherein the plant comprises:
a first dehydration unit for reducing the amount of water in a mixture comprising the one or more organic carbonates in a total amount of 90% by weight or more, based on the total amount of the mixture,
a mixing unit for mixing the mixture produced in the first dehydration unit with the one or more compounds selected from the group consisting of an acid with a pKa below 4 and a precursor releasing acid with a pKa below 4 in the liquid starting mixture by hydrolysis,
a first transferring equipment for transferring the mixture produced in the first dehydration unit to the mixing unit,
a measuring unit for determining the amount of water in the mixture produced in the mixing unit,
a second dehydration unit for reducing the amount of water in the mixture produced in the mixing unit, the second dehydration unit comprising an amount of a zeolite molecular sieve for contacting with said mixture, and
a second transferring equipment for transferring the mixture produced in the mixing unit to the second dehydration unit.

14: The plant according to claim 13, wherein said second transferring equipment is automated and provides for an automatic transfer depending on the result of the determination of the amount of water in the measuring unit.

15: The plant according to claim 13, wherein the second dehydration unit is a column comprising an amount of the zeolite molecular sieve.

16: The method according to claim 8, wherein two or more organic carbonates of Formula (I) are present and wherein R1 and R2 are independently selected for each organic carbonate.
